(19) United States
(12) Patent Application Publication
(10) Pub. No.: US 2024/0359848 A1
(43) Pub. Date: Oct. 31, 2024

(54) SYSTEM, METHOD, AND APPARATUS FOR CAPSULE FABRICATION

(71) Applicant: Multiply Labs Inc., San Francisco, CA (US)

(72) Inventors: Adrian TANNER, San Francisco, CA (US); Jeffrey Ackerman CURHAN, Warwick, RI (US); Joaquin GIRALDO-LAGUNA, San Francisco, CA (US); Michelle CHEN, San Francisco, CA (US); Nadia KRECIGLOWA, San Francisco, CA (US); Roger Siener LO, San Francisco, CA (US); Seb WAH, San Francisco, CA (US); Varun BHATIA, San Francisco, CA (US); Xiaojie CHEN, Suzhou City (CN)

(21) Appl. No.: 18/649,984

(22) Filed: Apr. 29, 2024

Related U.S. Application Data
(60) Provisional application No. 63/499,187, filed on Apr. 28, 2023.

(51) Int. Cl. B65B 43/46; A61J 3/07; B25J 9/10; B25J 15/00; B65B 1/32; B65B 39/00; B65B 57/00; B65D 88/26; B65D 90/58

(52) U.S. Cl. CPC B65B 43/46; A61J 3/074; B25J 9/106; B25J 15/0033; B65B 1/32; B65B 39/007; B65B 57/00; B65D 88/26; B65D 90/582

(57) ABSTRACT

System, method, and device for fabricating a capsule are provided. A gripping apparatus includes a rotary actuator and a rotary linkage disposed about a periphery of the rotary actuator. A plurality of intermediate linkages is coupled to the rotary linkage. Each intermediate linkage includes an input end portion coupled to the rotary linkage, an output end portion disposed below the input end portion, and a jaw disposed on the output end portion. The gripping apparatus includes a plurality of compliance linkages. Each compliance linkage includes a first end portion coupled to either the output end portion or the jaw of a respective intermediate linkage, and a second end portion substantially orthogonal to the respective intermediate linkage.

### CROSS-REFERENCE TO RELATED APPLICATION

The present Application claims priority to U.S. Provisional Patent Application No. 63/499,187, entitled “System, Method, and Apparatus for Capsule Fabrication, filed Apr. 28, 2023, which is incorporated herein by reference in its entirety for all purposes.

### TECHNICAL FIELD

The present invention is directed to systems, methods, and apparatuses for fabricating a capsule.

### BACKGROUND

Traditionally, capsules are produced with labor-intensive processes. These conventional processes require not only a large number of manufacturing operators, but also the employment of highly skilled (and expensive) technicians. These constraints make it particularly difficult to manufacture capsules at an industrial scale.

Given the above background, what is needed in the art are improved systems, methods, and apparatuses for manufacture of capsules.

### SUMMARY

Advantageously, the systems, methods, and apparatuses detailed in the present disclosure address the shortcomings in the prior art detailed above.

Systems, methods, and apparatuses for broadly implementing assembly of a plurality of capsules are provided.

Exemplary systems, methods, and apparatuses of the present disclosure provide for forming one, or a plurality of capsules and/or assembling the capsule or plurality of capsules. In some embodiments, the capsule, or each capsule in the plurality of capsules is a multi-compartment capsule.

An exemplary embodiment of the present invention provides a funnel apparatus. An exemplary funnel apparatus includes a base further including a first surface and a second surface. The first surface of the base includes an opening or a plurality of openings. The opening, or each opening in the plurality of openings, includes a first length for receiving a body, such as a capsule body. In various embodiments, the second surface is substantially perpendicular to the first surface, which allows for geometric differentiation of the first and second surfaces. The second surface includes a connecting member disposed on the second surface. Furthermore, the funnel apparatus includes a tray having a third surface. The third surface includes a through-hole, or a plurality of through-holes, in which the through hole, or each through-hole in the plurality of through-holes, substantially aligns with the opening, or a corresponding opening in the plurality of openings, of the base. Additionally, the tray has a fourth surface. In an exemplary embodiment, the fourth surface of the tray is substantially perpendicular to the third surface. An exemplary fourth surface includes a mating member for receiving the connecting member of the base.

In some embodiments, the first surface is recessed from and perpendicular to the second surface.

In some embodiments, one or both the first surface and the third surface each includes a flat plane.

In some embodiments, one or more openings in the plurality of openings and/or one or more through-holes in the plurality of through-holes includes a rounded edge portion, a chamfer edge portion, a beveled edge portion, or a combination thereof.

In some embodiments, one or more openings in the plurality of openings and/or one or more through-holes in the plurality of through-holes includes a first chamfer and a second chamfer. The first chamfer extends about a periphery of the respective opening or the respective through-hole, and the second chamfer extends about a periphery of the first chamfer and a side-wall of the respective opening or the respective through-hole.

In some embodiments, a first length of the first chamfer is less than a second length of the second chamfer.

In some embodiments, a first angle of the first chamfer is less than a second angle of the second chamfer.

In some embodiments, the plurality of openings forms a first array. Moreover, a center of the first array is offset from a center of the first surface.

In some embodiments, one or more through-holes or the plurality of through-holes forms a second array. Moreover, a center of the second array is offset from a center of the third surface.

In some embodiments, the base includes a first gate disposed on the second surface. Moreover, the tray includes a second gate disposed on the fourth surface.

In some embodiments, the opening or one or more openings in the plurality of openings includes a lower surface. Moreover, the lower surface includes concave curvature.

In some embodiments, the base includes a first side wall extending upwardly from the first surface. Moreover, the tray includes a second side extending downwardly from the third surface. Moreover, an interior surface of the second surface is configured to be accommodated by the first side wall of the base.

In some embodiments, the connecting member includes a first protrusion. Additionally, the mating member includes a first groove for receiving the first protrusion.

In some embodiments, the connecting member includes a second groove. Additionally, the mating member includes a second protrusion accommodated by the second groove.

An exemplary embodiment of the present invention provides a capsule assembly apparatus. The capsule assembly apparatus includes a hopper configured to retain a dosage form or a plurality of a solid dosage forms. The hopper includes an inlet for receiving a solid dosage form, or a member in the plurality of solid dosage forms. Moreover, the hopper includes an outlet for conveying the solid dosage form, or member in the plurality of solid dosage forms towards a dispenser. The dispenser includes a channel or a plurality of channels configured to receive the member in the plurality of solid dosage forms at an inlet of the channel or a respective channel and dispense the member at an outlet of the channel or the respective channel. Furthermore, the capsule assembly apparatus includes a rotary gate disposed interposing between the outlet of the hopper and the channel or the inlet of each channel in the plurality of channels. The rotary gate is configured to control conveying of the member in the plurality of solid dosage forms. Furthermore, the actuator is configured to control a movement of the rotary gate in a first direction.

In some embodiments, the outlet of the hopper is disposed at a position at or above of the maximum height of the respective channel of the dispenser.

In some embodiments, the rotary gate includes a flipper extending from a first surface of the rotary gate to a side wall of a housing that accommodates the hopper and the rotary gate.

In some embodiments, the flipper includes a first planar surface and a second planar surface opposing the first surface.

In some embodiments, the flipper includes a flexible material.

In some embodiments, a first length of the flipper is greater than a second length of the side wall of the housing.

In some embodiments, the rotary gate possesses two rotational degrees of freedom.

In some embodiments, the capsule assembly apparatus further includes a cam gate. The cam gate includes a first cam and a second cam. The first cam is configured to control the conveyance of the member in the plurality of solid dosage forms received by the channel, and the second cam is configured to control the conveying of the member in the plurality of solid dosage forms discharged by the channel.

In some embodiments, the first cam and the second cam collectively utilize an actuator.

In some embodiments, the capsule assembly apparatus further includes a sliding gate disposed below a lower surface of the dispenser. The sliding gate is configured to control discharge of the member in the plurality of solid dosage forms from the dispenser.

In some embodiments, the sliding gate includes a metering plate.

In some embodiments, the sliding gate is configurable between a first position in which an aperture of a metering hole of the metering plate and an aperture of a dispensing hole in the dispenser are misaligned, and a second position in which the aperture of the metering hole and the aperture of the dispensing hole are aligned.

In some embodiments, the dispenser further includes a surface extending from an upper end portion of the dispenser towards the outlet of the hopper.

In some embodiments, a solid dosage form in the plurality of solid dosage forms includes a first size between 2 mm and 35 mm.

In some embodiments, a solid dosage form in the first plurality of solid dosage forms includes a rotationally symmetrical body that further includes a side wall and a base.

An exemplary embodiment of the present invention provides a gripping apparatus. The gripping apparatus includes a rotary actuator and a rotary linkage. The rotary linkage includes a first end portion at least partially disposed about a periphery of the rotary actuator. Additionally, the rotary link includes a second end portion extending outwardly from the first end portion. The gripping apparatus further includes an intermediate linkage or a plurality of intermediate linkages coupled to the second end portion of the rotary linkage. The intermediate linkage or each intermediate linkage in the plurality of intermediate linkages includes an input end portion, and output end portion, and a jaw. The input end portion is coupled to the second end portion of the rotary linkage, the output end portion is disposed below the input end portion, and the jaw is disposed on the output end portion. Furthermore, the gripping apparatus includes a compliance linkage or a plurality of compliance linkages. The compliance linkage or a compliance linkage in the plurality of compliance linkages includes a first end portion and a second end portion. The first end portion is coupled to either the output end portion or the jaw of a respective intermediate linkage, and the second end portion substantially orthogonal to the respective intermediate linkage.

In some embodiments, a distance travelled between an OPEN state and a CLOSED state of each jaw is 15 millimeters or less.

In some embodiments, the gripping apparatus further includes a mount. The mount includes a first end portion coupled to the rotary actuator and a second end portion coupled to the second end portion of the compliance linkage or one or more compliance linkage sin the plurality of compliance linkages.

In some embodiments, a jaw is selected from the group consisting of a tentacle, a cup, a cone, a chuck, a latch, a hook, a clamp, a pincer, a tong, or a combination thereof.

In some embodiments, the compliance linkage or one or more compliance linkages in the plurality of compliance linkages includes one or more side walls. Moreover, each side wall in the one or more side walls extends downwardly from a first surface of the rotary actuator to a corresponding jaw.

In some embodiments, the intermediate linkage or one or more intermediate linkages in the plurality of intermediate linkages translated rotational motion of the rotary linkage into translational motion of the jaw.

In some embodiments the compliance linkage or one or more compliance linkages in the plurality of compliance linkages resists motion parallel to a rotational axis of the rotary actuator.

In some embodiments, the compliance linkage or one or more compliance linkages in the plurality of compliance linkages is configured to prevent movement beyond a predetermined limit.

In some embodiments, a jaw is disposed at a distal end portion of the gripping apparatus.

An exemplary embodiment of the present invention provides a sensor apparatus. The sensor apparatus includes a nest unit including a first opening. The first opening includes a side wall that includes a contoured surface or a plurality of contoured surfaces arranged circumferentially about the side wall. Moreover, the sensor opening includes a second opening opposing the first opening. The second opening is configured to accommodate a portion of a sensor. A first housing includes a first opening configured to accommodate the nest unit. Moreover, the sensor is disposed on a base, in which the sensor includes a translational degree of freedom.

In some embodiments, the sensor apparatus further includes a second housing. The second housing includes a second opening further including a second diameter less than a first diameter of the first housing.

In some embodiments, the first housing is disposed on an upper surface of the second housing.

In some embodiments, the second housing is configured to surround some or all of the base and the sensor.

In some embodiments, the second housing includes a flange surrounding some or all of the sensor.

In some embodiments, the side wall is cylindrical.

In some embodiments, one or more adjacent contoured surfaces in the plurality of contoured surfaces are spaced apart from each other.

In some embodiments, one or more contoured surfaces in the plurality of contoured surfaces are substantially uniformly distributed in a circumferential direction.

In some embodiments, the plurality of contoured surfaces includes at least 2, at least 3, at least 4, or at least 5 contoured surfaces.

In some embodiments, one or more contoured surfaces includes a concave portion of the side wall.

In some embodiments, the sensor includes a mass sensor.

In some embodiments, the sensor continuously determines a mass of the nest unit.

An exemplary embodiment of the present invention provides a computer system for fabricating a capsule.

An exemplary embodiment of the present invention provides a computer readable storage medium storing one or more programs. The one or more programs include instructions, which when executed by an electronic device with one or more processors and a memory, cause the electronic device to execute a method for fabricating a capsule.

An exemplary embodiment of the present invention provides a method for fabricating a capsule.

An exemplary embodiment of the present invention provides apparatuses for fabricating a capsule. In some embodiments, the apparatuses for fabricating the capsule including a capsule loading apparatus, a capsule divider apparatus, a capsule funnel apparatus, a capsule tray apparatus, a docking apparatus, a gripper apparatus, a metering apparatus, a gate apparatus, a flipper apparatus, a hopper apparatus, an actuator apparatus, a track apparatus, a sensor apparatus, or a combination thereof.

### BRIEF DESCRIPTION OF THE DRAWINGS

The accompanying drawings, which are incorporated into and constitute a part of this specification, illustrate one or more exemplary embodiments of the present disclosure and, together with the Detailed Description, serve to explain the principles and implementations of exemplary embodiments of the invention. The accompanying drawings are not necessarily to scale. The specific design features of the present invention as disclosed herein, including, for example, specific dimensions, orientations, locations, and shapes will be determined in part by the particular intended application and use environment. Reference numbers refer to the same or equivalent parts of the present invention throughout the figure(s) of the drawings. In addition, the components illustrated in the figures are combinable in any useful number and combination.

FIG. 1 illustrates various modules and/or components of a computer system for fabricating a capsule, in accordance with an embodiment of the present disclosure.

FIG. 2 is a flowchart illustrating an exemplary method for connecting or disconnecting units in accordance with some embodiments of the present disclosure.

FIG. 3 is a perspective view of a gripper apparatus including a mount in accordance with some embodiments of the present disclosure.

FIG. 4 is a side view of a gripper apparatus including a mount in accordance with some embodiments of the present disclosure.

FIG. 5 is a bottom view of a gripper apparatus including a mount in accordance with some embodiments of the present disclosure.

FIG. 6 is a top view of a gripper apparatus in accordance with some embodiments of the present disclosure.

FIG. 7 is a perspective view of a docking apparatus including a plurality of trays in accordance with some embodiments of the present disclosure.

FIG. 8 is another perspective view of a docking apparatus including a plurality of trays with one or more funnel devices in accordance with some embodiments of the present disclosure.

FIG. 9 is a side view of a docking apparatus including a plurality of trays in accordance with some embodiments of the present disclosure.

FIG. 10A is a rear view of a docking apparatus including a plurality of trays in accordance with some embodiments of the present disclosure.

FIG. 10B is an enlarged view of FIG. 10A.

FIG. 10C is an alternative perspective view of FIG. 10A.

FIG. 11 is a top view of a docking apparatus including a tray in accordance with some embodiments of the present disclosure.

FIG. 12 is a bottom view of a docking apparatus in accordance with some embodiments of the present disclosure.

FIG. 13 is another side view of a docking apparatus including a plurality of trays further including a plurality of funnel devices in accordance with some embodiments of the present disclosure.

FIG. 14 is a front view of the docking apparatus of FIG. 13.

FIG. 15 is a perspective view of a sensor apparatus in accordance with some embodiments of the present disclosure.

FIG. 16 is a side view of a sensor apparatus in accordance with some embodiments of the present disclosure.

FIG. 17 is a perspective view of a sensor apparatus including a nest unit and a housing in accordance with some embodiments of the present disclosure.

FIG. 18 is another perspective view of a sensor apparatus including a nest unit and a housing in accordance with some embodiments of the present disclosure.

FIG. 19 is another perspective view of a sensor apparatus including a nest unit and a housing in accordance with some embodiments of the present disclosure.

FIG. 20 is a cross-sectional view taken along line A-A of FIG. 16.

FIG. 21 is another cross-sectional view taken along line A-A of FIG. 16.

FIG. 22 is yet another cross-sectional view taken along line A-A of FIG. 16.

FIG. 23 is a cross-sectional view taken along line B-B of FIG. 19.

FIG. 24 is a cross-sectional view taken along line C-C of FIG. 23.

FIG. 25 is a perspective view of a capsule assembly apparatus in accordance with some embodiments of the present disclosure.

FIG. 26 is another perspective view of a capsule assembly apparatus in accordance with some embodiments of the present disclosure.

FIG. 27 is a top view of a capsule assembly apparatus in accordance with some embodiments of the present disclosure.

FIG. 28 is yet another perspective view of a capsule assembly apparatus in accordance with some embodiments of the present disclosure.

FIG. 29 is yet another perspective view of a capsule assembly apparatus in accordance with some embodiments of the present disclosure.

FIG. 30 is yet another perspective view of a capsule assembly apparatus in accordance with some embodiments of the present disclosure.

FIG. 31 is yet another perspective view of a capsule assembly apparatus in accordance with some embodiments of the present disclosure.

FIG. 32 is yet another perspective view of a capsule assembly apparatus in accordance with some embodiments of the present disclosure.

FIG. 33 is yet another perspective view of a capsule assembly apparatus in accordance with some embodiments of the present disclosure.

FIG. 34 is a perspective view of a funnel apparatus in accordance with some embodiments of the present disclosure.

FIG. 35 is another perspective view of a funnel apparatus in accordance with some embodiments of the present disclosure.

FIG. 36 is a top view of a funnel apparatus in accordance with some embodiments of the present disclosure.

FIG. 37 is a sectional view taken along line D-D of FIG. 34.

FIG. 38 is a perspective view of a funnel apparatus in accordance with some embodiments of the present disclosure.

FIG. 39 is another perspective view of a funnel apparatus in accordance with some embodiments of the present disclosure.

FIG. 40 is a top view of a funnel apparatus in accordance with some embodiments of the present disclosure.

FIG. 41 is a sectional view taken along line E-E of FIG. 40.

FIG. 42 is a perspective view of a pin device in accordance with some embodiments of the present disclosure.

FIG. 43 is a perspective view of a pin device in accordance with some embodiments of the present disclosure.

FIG. 44 is a side view of a pin device in accordance with some embodiments of the present disclosure.

FIG. 45 is a perspective view of a funnel device and a second funnel device in accordance with some embodiments of the present disclosure.

FIG. 46 is a perspective view of a funnel device and a second funnel device in accordance with some embodiments of the present disclosure.

FIG. 47 is a perspective view of a funnel device and a second funnel device in accordance with some embodiments of the present disclosure.

FIG. 48 is a perspective view of a funnel device and a second funnel device in accordance with some embodiments of the present disclosure.

FIG. 49 is a perspective view of a funnel device and a second funnel device in accordance with some embodiments of the present disclosure.

FIG. 50 is a perspective view of a funnel device and a second funnel device in accordance with some embodiments of the present disclosure.

FIGS. 51-55 collectively illustrate views of an apparatus for fabricating a capsule in accordance with some embodiments of the present disclosure.

### DETAILED DESCRIPTION

The present disclosure provides systems, methods, and apparatuses for facilitating automated assembly of a plurality of capsules. Exemplary systems, methods, and apparatuses for the assembly of the plurality of capsules of the present disclosure includes the advantages of modularity, flexibility, and scalability. Moreover, exemplary systems, methods, and apparatuses of the present disclosure retain the benefits of a conventional closed-system processes, such as by providing a sterile clean room environment, without sacrificing the aforementioned advantages. Furthermore, exemplary systems, methods, and apparatus of the present disclosure leverage advanced robotic features and technologies that enable the transformation of capsule assembly from labor-based and low-throughput process to a fully industrialized, high-throughput process with high scale, efficiency, and repeatability.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, and components have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For instance, a first property could be termed a second property, and, similarly, a second property could be termed a first property, without departing from the scope of the present disclosure. The first property and the second property are both properties, but they are not the same property.

The terminology used in the present disclosure is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description included example systems, methods, techniques, instruction sequences, and computing machine program products that embody illustrative implementations. For purposes of explanation, numerous specific details are set forth in order to provide an understanding of various implementations of the inventive subject matter. It will be evident, however, to those skilled in the art that implementations of the inventive subject matter may be practiced without these specific details. In general, well-known instruction instances, protocols, structures, and techniques have not been shown in detail.

The foregoing description, for purpose of explanation, has been described with reference to specific implementations. However, the illustrative discussions below are not intended to be exhaustive or to limit the implementations to the precise forms disclosed. Many modifications and variations are possible in view of the above teachings. The implementations are chosen and described in order to best explain the principles and their practical applications, to thereby enable others skilled in the art to best utilize the implementations and various implementations with various modifications as are suited to the particular use contemplated.

In the interest of clarity, not all of the routine features of the implementations described herein are shown and described. It will be appreciated that, in the development of any such actual implementation, numerous implementation-specific decisions are made in order to achieve the designer's specific goals, such as compliance with use case-and business-related constraints, and that these specific goals will vary from one implementation to another and from one designer to another. Moreover, it will be appreciated that such a design effort might be complex and time-consuming, but nevertheless be a routine undertaking of engineering for those of ordering skill in the art having the benefit of the present disclosure.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

As used herein, the term “substantially,” “about,” or “approximately,” can mean within an acceptable error range for the particular value as determined by one of ordinary skill in the art, which can depend in part on how the value is measured or determined, e.g., the limitations of the measurement system. For example, “about” can mean within 1 or more than 1 standard deviation, per the practice in the art. “About” can mean a range of ±20%, ±10%, ±5%, or ±1% of a given value. Where particular values are described in the application and claims, unless otherwise stated, the term “about” means within an acceptable error range for the particular value. The term “about” can have the meaning as commonly understood by one of ordinary skill in the art. The term “about” can refer to ±10%. The term “about” can refer to ±5%.

Furthermore, when a reference number is given an “i^{th}” denotation, the reference number refers to a generic component, set, or embodiment. For instance, a body termed “body i” refers to the i^{th} body in a plurality of bodies (e.g., a body 5000-i in a plurality of bodies 5000).

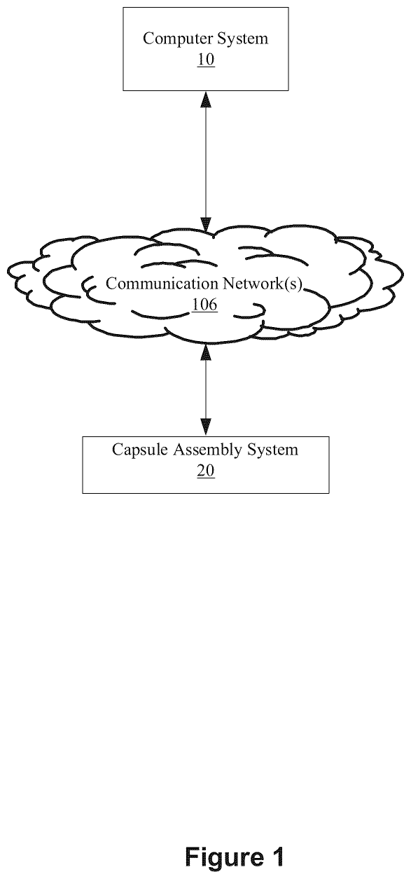

In the present disclosure, unless expressly stated otherwise, descriptions of devices and systems will include implementations of one or more computers. For instance, and for purposes of illustration in FIG. 1, a computer system 1200 is represented as single device that includes all the functionality of the computer system 1200. However, the present disclosure is not limited thereto. For instance, in some embodiments, the functionality of the computer system 1200 is spread across any number of networked computers and/or reside on each of several networked computers and/or by hosted on one or more virtual machines and/or containers at a remote location accessible across a communications network (e.g., communications network 1206 of FIG. 1). One of skill in the art will appreciate that a wide array of different computer topologies is possible for the computer system 1200, and other devices and systems of the preset disclosure, and that all such topologies are within the scope of the present disclosure. Moreover, rather than relying on a physical communications network 1206, the illustrated devices and systems may wirelessly transmit information between each other. As such, the exemplary topology shown in FIG. 1 merely serves to describe the features of an embodiment of the present disclosure in a manner that will be readily understood to one of skill in the art.

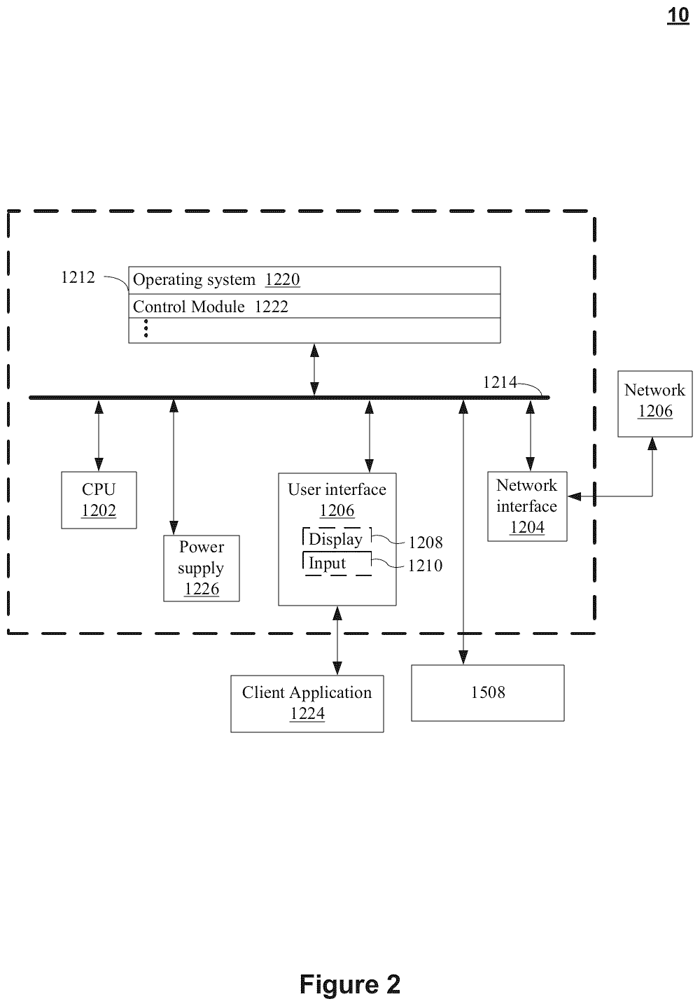

FIG. 2 depicts a block diagram of a distributed computer system (e.g., computer system 1200) according to some embodiments of the present disclosure. The computer system 1200 at least facilitates communicating one or more instructions for fabricating a capsule.

In some embodiments, the communication network 1206 optionally includes the Internet, one or more local area networks (LANs), one or more wide area networks (WANs), other types of networks, or a combination of such networks.

Examples of communication networks 1206 include the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

In various embodiments, the computer system 1200 includes one or more processing units (CPUs) 1202, a network or other communications interface 1204, and memory 1212.

In some embodiments, the computer system 1200 includes a user interface 1206. The user interface 1206 typically includes a display 1208 for presenting media. In some embodiments, the display 1208 is integrated within the computer systems (e.g., housed in the same chassis as the CPU 1202 and memory 1212). In some embodiments, the computer system 1200 includes one or more input device(s) 1210, which allow a subject to interact with the computer system 1200. In some embodiments, input devices 1210 include a keyboard, a mouse, and/or other input mechanisms. Alternatively, or in addition, in some embodiments, the display 1208 includes a touch-sensitive surface (e.g., where display 1208 is a touch-sensitive display or computer system 1200 includes a touch pad).

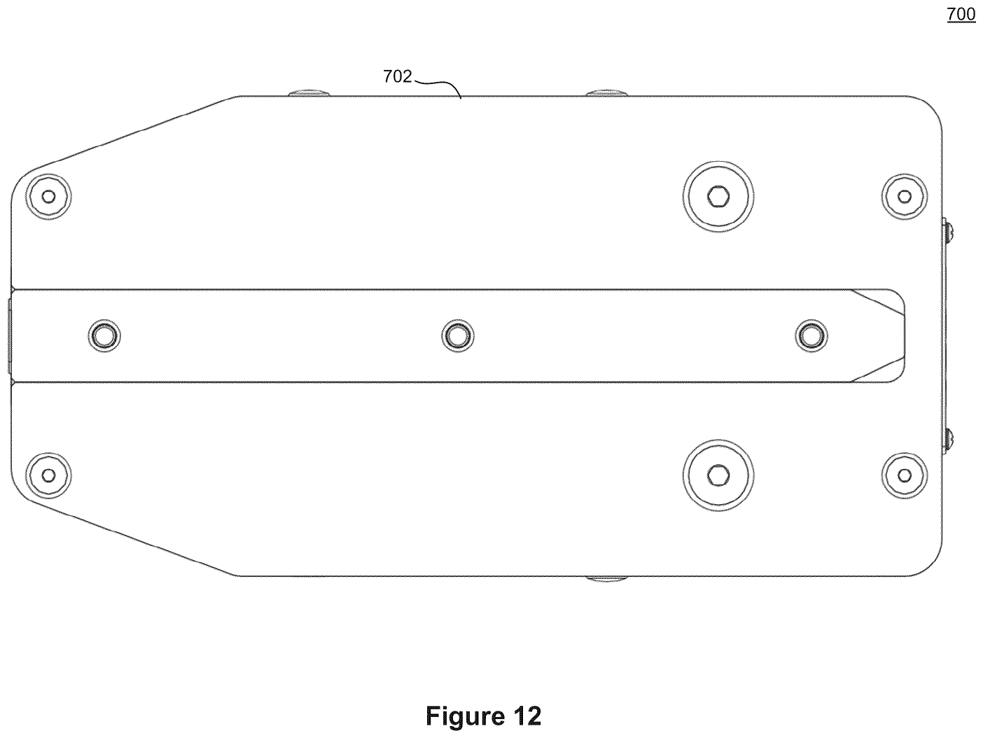

In some embodiments, the computer system 1200 presents media to a user through the display 1208. Examples of media presented by the display 1208 include one or more images, a video, audio (e.g., waveforms of an audio sample), or a combination thereof. In typical embodiments, the one or more images, the video, the audio, or the combination thereof is presented by the display 1208 through a client application (e.g., client application 1224 of FIG. 12). In some embodiments, the audio is presented through an external device (e.g., speakers, headphones, input/output (I/O) subsystem, etc.) that receives audio information from the computer system 1200 and presents audio data based on this audio information. In some embodiments, the user interface 1206 also includes an audio output device, such as speakers or an audio output for connecting with speakers, earphones, or headphones.

Memory 1212 includes high-speed random access memory, such as DRAM, SRAM, DDR RAM, or other random access solid state memory devices, and optionally also includes non-volatile memory, such as one or more magnetic disk storage devices, optical disk storage devices, flash memory devices, or other non-volatile solid state storage devices. Memory 1212 may optionally include one or more storage devices remotely located from the CPU(s) 1202. Memory 1212, or alternatively the non-volatile memory device(s) within memory 1212, includes a non-transitory computer readable storage medium. Access to memory 1292 by other components of the computer system 1200, such as the CPU(s) 1212, is, optionally, controlled by a controller. In some embodiments, memory 1212 can include mass storage that is remotely located with respect to the CPU(s) 1202. In other words, some data stored in memory 1212 may in fact be hosted on devices that are external to the computer system 1200, but that can be electronically accessed by the computer system 1200 over an Internet, intranet, or other form of network 1206 or electronic cable using communication interface 1204.

In some embodiments, the memory 1212 of the computer system 1200 stores:
an operating system 1220 (e.g., ANDROID, IOS, DARWIN, RTXC, LINUX, UNIX, OS X, WINDOWS, or an embedded operating system such as VxWorks) that includes procedures for handling various basic system services;
an electronic address associated with the computer system 1200 that identifies the computer system 1200 (e.g., within the communication network 1206);
a control module 1222 for controlling one or more instruments (e.g., an apparatus for a manufacture of a capsule) associated with the computer system 1200; and
a client application 1224 for presenting information (e.g., media) using a display 1278 of the computer system 1200.

As indicated above, an electronic address 1204 is associated with the computer system 1200. The electronic address 1214 is utilized to at least uniquely identify the computer system 1200 from other devices and components of the distributed system 1200, such as other devices having access to the communications network 1206

In various embodiments, the present disclosure is directed to providing an apparatus for fabricating a capsule. In some embodiments, the apparatus for fabricating the capsule is configured for a capsule loading, capsule dividing, funneling capsules, accommodating capsules, gripping capsules, metering capsules, gating capsules, actuating capsules, transporting capsules, sensing capsules, or a combination thereof.

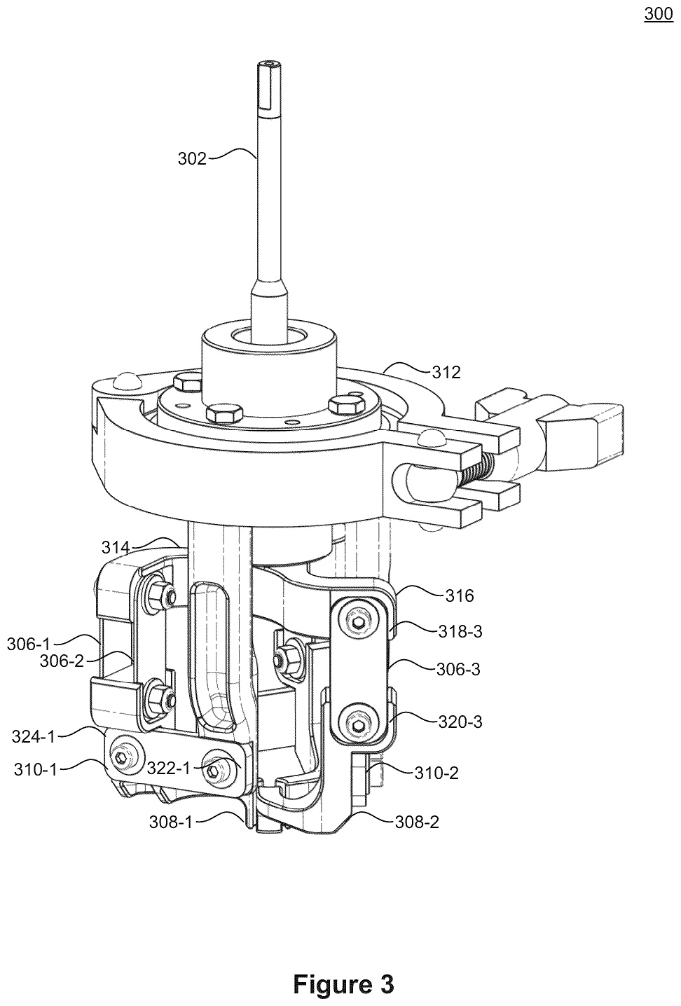

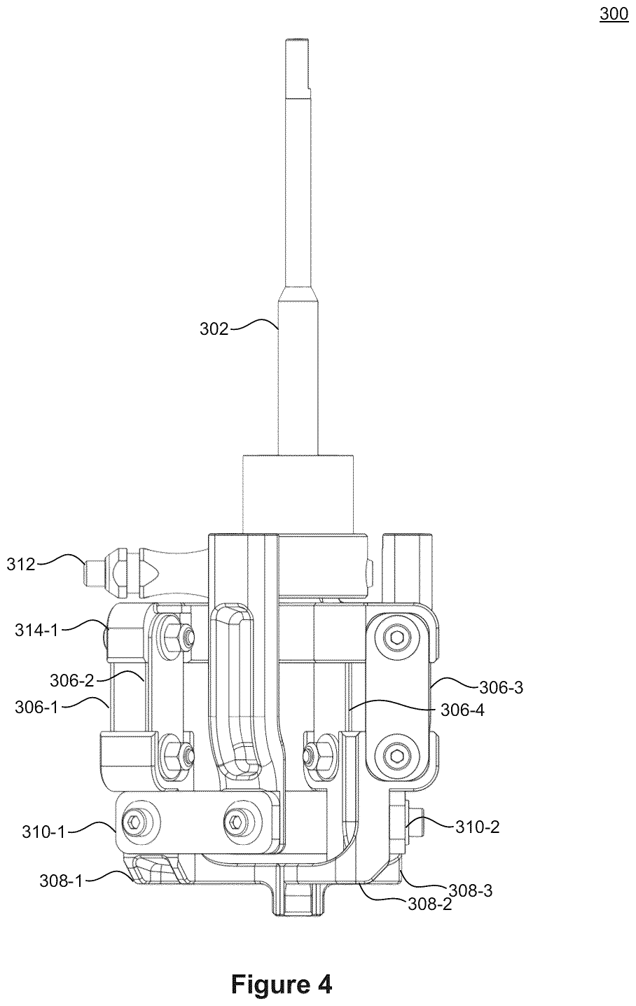

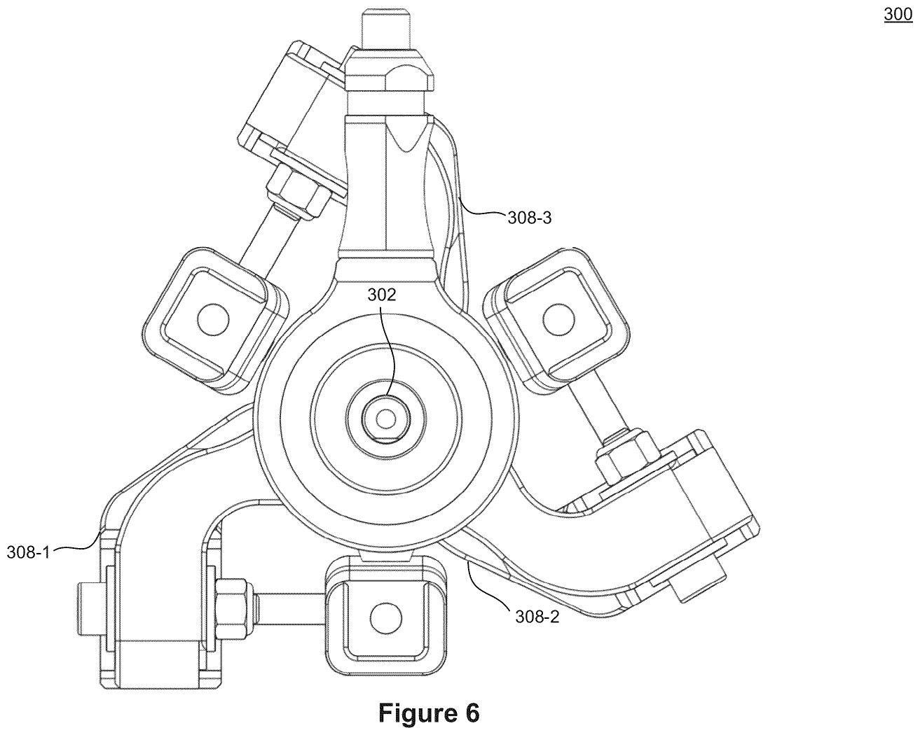

FIGS. 3-6 illustrate an exemplary gripping apparatus 300 in accordance with some embodiments of the present disclosure. In some embodiments, the gripping apparatus 300 generally includes a rotary actuator 302 and a rotary linkage 304 coupled to the rotary actuator 302, which allows the gripping apparatus 300 to further couple with existing structures and conventional actuator systems. For instance, in some embodiments, a longitudinal axis of the rotary actuator 302 and/or the rotary linkage 304 is parallel with a first axis of an articulated handling robot, such as an end-of-arm tooling (EOAT) center axis. In some embodiments, the rotary linkage 304 includes a first end portion that is at least partially disposed about a periphery of the rotary actuator 302, such as coupled against a circumference of a lower end portion of the rotary actuator 302, allowing for the first end portion 314 to transfer the rotational motion of the rotary actuator 302 to a second end portion 316 of the rotary linkage 304. Moreover, by using the rotary actuator 302, the gripping apparatus 300 is provided with a compact form that operates with fine tune, granular control in order to pick and/or place a body, such a capsule body or solid dosage form. For instance, in some embodiments, a closing force of the gripping apparatus 300 is controllable through actuation of the rotary linkage 304 via the rotary actuator 302. However, the present disclosure is not limited thereto.

In some embodiments, the rotary actuator 302 and/or the rotary linkage 304 is coupled with a mount 312, which can be an integral part of any apparatus or fixedly coupled with any apparatus. In some embodiments, the mount 312 provides a rigid body for coupling the gripping apparatus 300 to another structure or surface. For instance, in some embodiments, the gripping apparatus 300 is removably coupled to the mount 312 in order to prevent the gripping apparatus 300 from moving in a predetermined direction (e.g., laterally, longitudinally, rotationally). Nevertheless, the gripping apparatus 300 of the present disclosure is free to move and be used in one or more dimensions or a plurality of dimensions and in any spatial region in accordance with a design of the present invention, such as in accordance with a control and motion of an end portion of the rotary actuator 302. Moreover, as described infra, in some embodiments, the rigidity of the mount 312 allows for rotational and/or translational compliance when actuating the gripping apparatus 300 improving precision and control.

In some embodiments, the second end portion 316 extends outwardly from the first end portion 314 of the rotary linkage 304, such that the second end portion 316 is a distal to the rotary linkage 304. In the present exemplary embodiment, the rotary linkage 304 is configured as an arch shape or annular shape, such that one or more surfaces extend radially from a center of the rotary linkage 304. However, the present disclosure is not limited thereto. For instance, in some embodiments, the second end portion 316 of the rotary linkage 304 is distal end portion of a rectangular bar, two or more intersecting bars, a beam, a T-shaped bar disposed above, interposed by, interposing between, or disposed below the rotary actuator 302. In some embodiments, an intermediate linkage 306 or one or more intermediate linkages in a plurality of intermediate linkages 306 is coupled to the second end portion 316 of the rotary linkage 304. For instance, in some embodiments, at least two intermediate linkages 306, at least three intermediate linkages 306, at least four intermediate linkages 306, at least six intermediate linkages 306, at least ten intermediate linkages 306 at least twelve intermediate linkages 306, at least fifteen intermediate linkages 306, or more are coupled to the second end portion 316 of the rotary linkage 304. In some embodiments, an intermediate linkage 306 or one or more intermediate linkages is configured to couple predetermined linkages together, such that an input force is transferred from one portion of the device to another portion of the device. For instance, in some embodiments, the intermediate linkage 306 or one or more intermediate linkages includes an input end portion 318, and output end portion 320, and a jaw 308, which collectively allow the intermediate linkage to transfer motion from the rotary linkage 304 through to the jaw 308 allowing the gripping apparatus 300 to hold a body.

In some embodiments, a jaw 308 or one or more jaws 308 is disposed at a distal end portion of the gripping apparatus, such as a first end portion opposing the rotary linkage 304. In some embodiments, a distance travelled between an OPEN state and a CLOSED state of the jaw 308 is 15 millimeters or less.

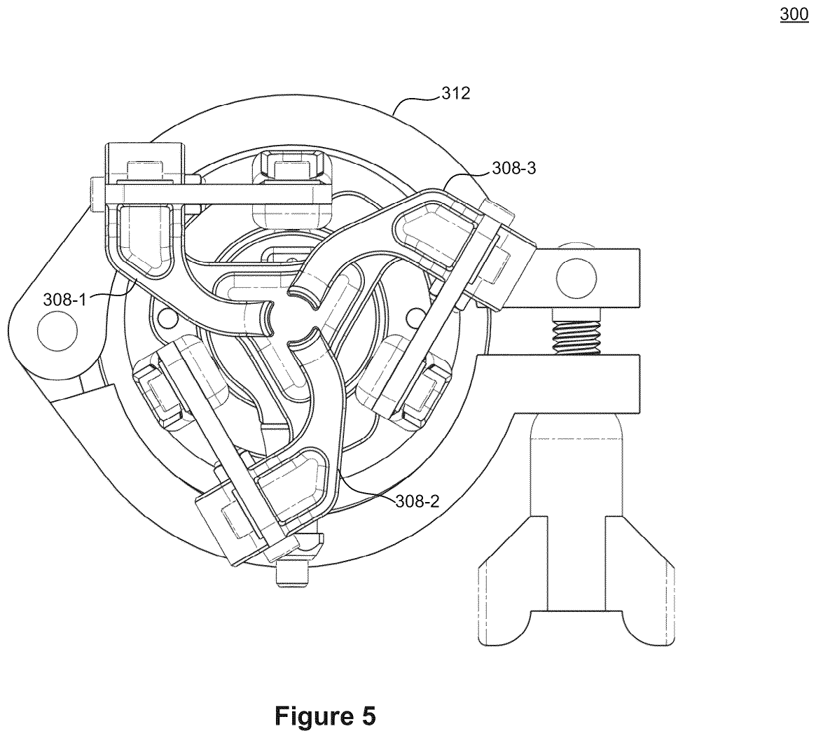

In some embodiments, the jaw include a recessed portion (e.g., portion 210 of FIG. 2) such as a portion of a cup and/or cone that is configured to hold a sloped object. For instance, as illustrated in FIG. 5, in some embodiments a portion of one or more jaws is formed in a concave shape in order to accommodate a target object (e.g., a capsule). Furthermore, in some embodiments, one or more respective jaws includes one or more protrusions (e.g., teeth) that are configured to engage a target object in order to better grip the object. In some embodiments, one or more jaws 308 is selected from the group consisting of a tentacle, a cup, a conc, a chuck, a latch, a hook, a clamp, a pincer, a tong, or a combination thereof. In some embodiments, the gripping apparatus 300 operates two or more jaws 308 in unison allowing for the gripping apparatus 300 to apply uniform force to an exterior surface of the body, which advantageously prevents mechanical degradation of the body, such as crushing.

In some embodiments, a default state of the gripping apparatus 300 is an OPEN state, which a rotational force is not applied by the rotary actuator 302. For instance, in the OPEN default state, if an input force is applied to the rotary linkage 304 via the rotary actuator 302, the jaw 308 move towards one another to decrease a size of a gap there between, such as in order to hold or pick a body from a surface. In some embodiments, a default state of the gripping apparatus 300 is a CLOSED state. In the CLOSED default state, if an input force is applied to the rotary linkage 304 the jaw 308 move away from another jaw to form, or increase, the size of the gap there between, such as in order to drop or place the body onto the surface. In the exemplary embodiments, a rotational input force is applied linearly to the jaw 308 via the intermediate linkages 306. However, the present invention is not limited thereto. In some embodiments, an input force is applied to the jaw 308 in order to force the intermediate linkages 306 to move and/or bend, such as by one or more compliance linkages 310 of the gripping apparatus 300. In some embodiments, a distance travelled between an OPEN state and a CLOSED state of one or more jaws 308 is 15 millimeters (mm) or less. In some embodiments, a distance travelled between an OPEN state and a CLOSED state of one or more jaws 308 is 10 millimeters or less. In some embodiments, a distance travelled between an OPEN state and a CLOSED state of one or more jaws 308 is 6 millimeters or less. In some embodiments, a distance travelled between an OPEN state and a CLOSED state of one or more jaws 308 is 5 millimeters or less. In some embodiments, a distance travelled between an OPEN state and a CLOSED state of one or more jaws 308 is 3 millimeters or less. In some embodiments, a distance travelled between an OPEN state and a CLOSED state of one or more jaws 308 is 1 millimeter or less. A distanced travelled between an OPEN state and a CLOSED state of one or more jaws 308 typically depends on an object to be grasped and a force required to hold the object. For instance, in some embodiments a pharmaceutical capsule has an approximate diameter of 4.1 mm. Accordingly, a distanced travelled between an OPEN state and a CLOSED state of one or more jaws 308 is greater than or equal to 2.1 mm.

Due to a lack of sliding and/or moving parts, friction is not generated during operation of the jaw 308, thus preventing fine particle from being gencrated. In some embodiments, this lack of particles is an essential feature when the gripping apparatus 300 is utilized in microscopic domains, such as clean room environments. Moreover, the intermediate linkage 306 of the present disclosure provide internal compliances to ensure components remain aligned.

In some embodiments, the gripping apparatus 300 includes one or more compliance in a plurality of compliance linkages 310, which provide rigidity parallel to the longitudinal axis of the gripping apparatus 300. In some embodiments, the mount 312 includes a first end portion coupled to the rotary actuator 302 and a second end portion coupled to a first end portion 322 of the compliance linkage 310 or one or more compliance linkages 310. However, the present invention is not limited thereto. As a non-limiting example, in some embodiments, a compliance linkage 310 includes one or more side walls extending downwardly from a first surface of the rotary actuator 302 to a corresponding jaw 308. In some embodiments, the compliance linkage 310 or one or more compliance linkages 310 includes the first end portion 322 and a second end portion 324 opposing the first end portion 322. In some embodiments, the first end portion 322 of the compliance linkage 310 or one or more compliance linkages 310 is coupled to either the output end portion 320 of the intermediate linkage 306 or the jaw 308 of the intermediate linkage 306, which allows for the compliance linkage 310 to resist and/or force a motion of the jaw 308. Moreover, in some embodiments, the second end portion 324 of the compliance linkage 310 is substantially orthogonal to the intermediate linkage 310, which allows for the compliance linkage 310 to provide radial return spring action, planar rigidity parallel to the longitudinal axis of the gripping apparatus, the EOAT center axis, or a combination thereof. In some embodiments, the compliance linkage 310 of the present disclosure provides internal compliances to ensure components, such as the jaws 308, remain aligned. In some embodiments, the compliance linkage 310 assist in transforming a direction of an input force from a first direction to a second direction (e.g., from a motion in a first plane to a motion in a second plane), dampening an input force, as well as maintaining alignment of the jaws 308 and/or the intermediate linkages 306. One of skill in the art will appreciate that design parameters of the intermediate linkages 306 and/or the compliance linkages 310 include, but are not limited to, a thickness and/or a gradient/tapering thereof, a width and/or a gradient/tapering thereof, one or more materials included in the intermediate linkages 306 and/or the compliance linkages 310, a desired output force exerted by the gripping apparatus 300, and the like.

Advantageously, in some embodiments, the gripping apparatus 300 includes one or more compliant linkages 310 that actuation through spring action, which provides no wear components that would otherwise generate contaminating particulates. Furthermore, the intermediate linkages 306 allow for gentle grip on fragile bodies, tuning of closing force with position control of the rotary actuator 302, rotational actuation through an articulated handling robot, integrates to existing actuation architectures, toolless disassembly from robot for service or cleaning, sanitary grade clamp, spring loaded locking pin, or a combination thereof. However, the present disclosure is not limited thereto.

In some embodiments, the gripping apparatus 300 remains in a fixed angular position due to the mount 312 coupled to the rotary linkage 304. In some embodiments, if the rotary actuator 302 is rotated which by rigid connection rotates the rotary linkage 304 further translating rotation motion to the intermediate linkages 306 that are connected to a jaw 308 causing the jaw 308 to move in along a radial path either converging towards a longitudinal axis and/or center axis of the gripping apparatus 300 for closing operation, or diverging away from the longitudinal axis and/or center axis for opening gripping apparatus 300. In some embodiments, the compliance linkages 310 connected to the jaws 308 act as a return spring to the neutral position of the jaws 308 while also providing a function of a rigid planar alignment linkage to the jaw 308 resisting motion parallel to the longitudinal axis and/or center axis of the gripping apparatus 300. However, the present disclosure is not limited thereto.

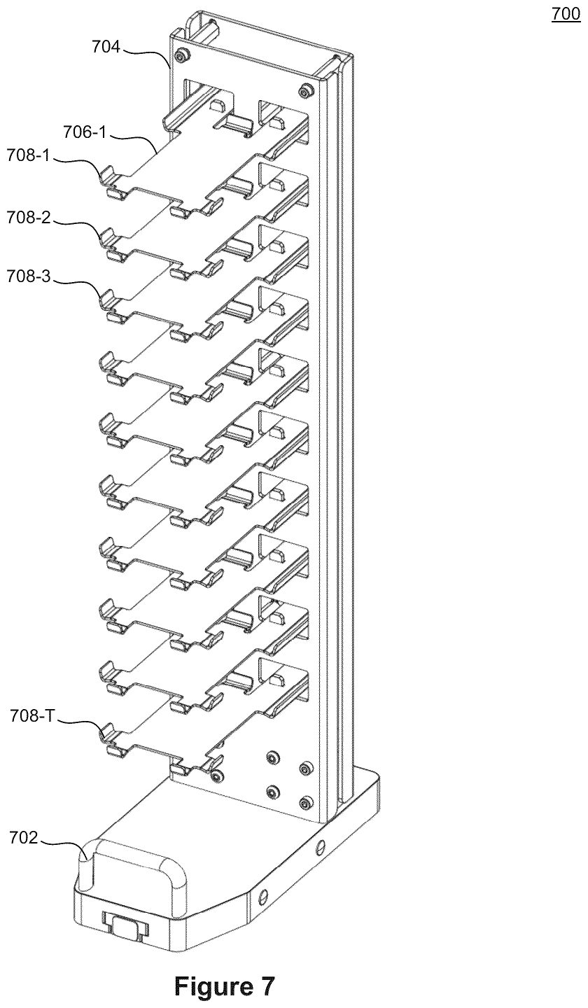

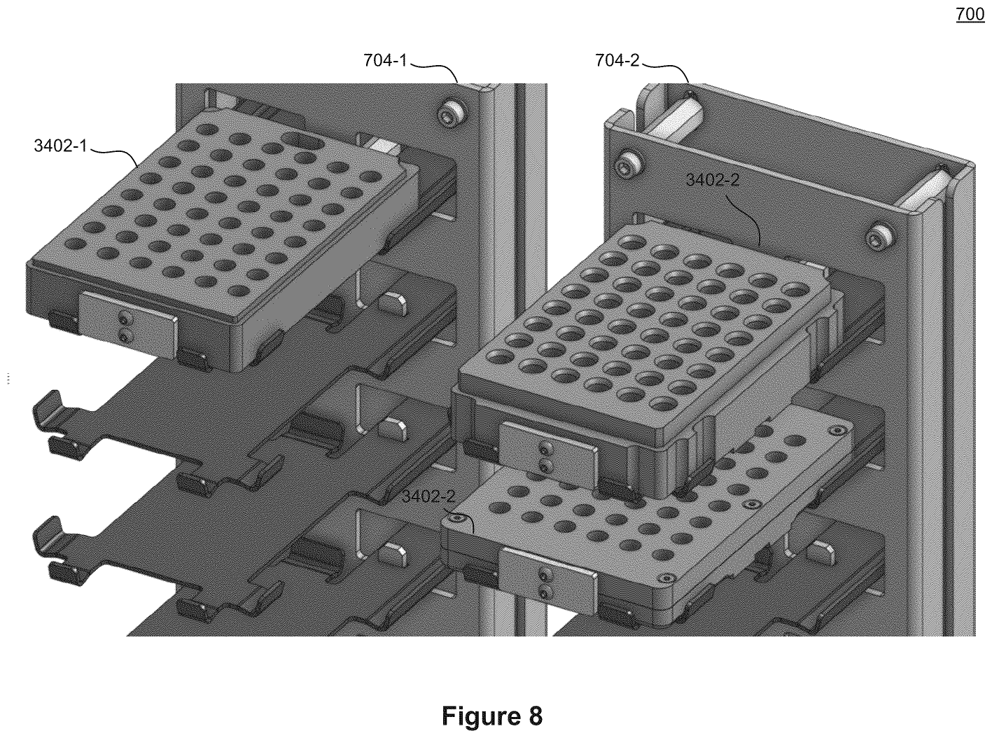

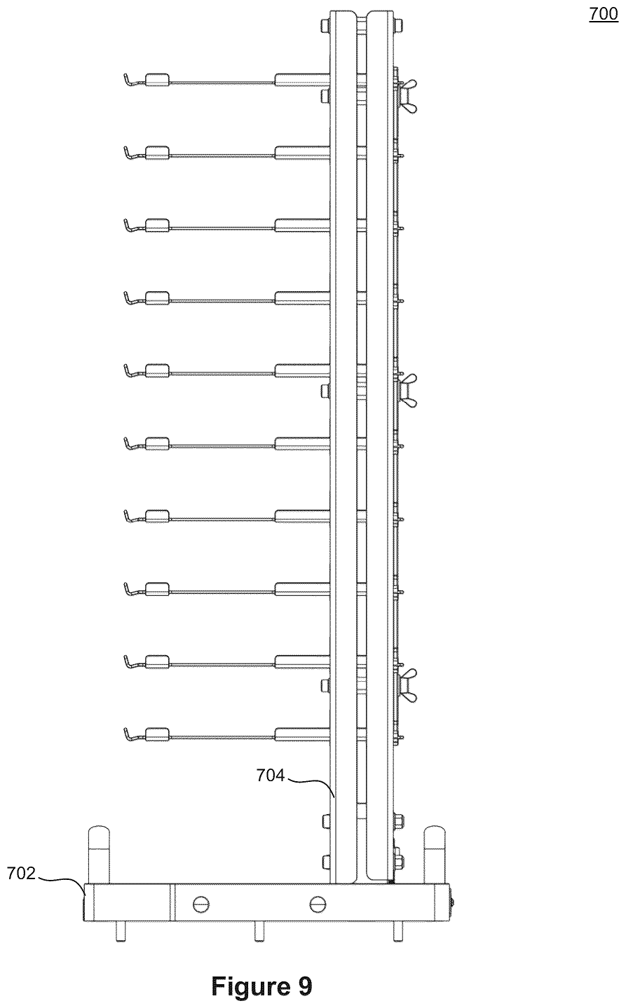

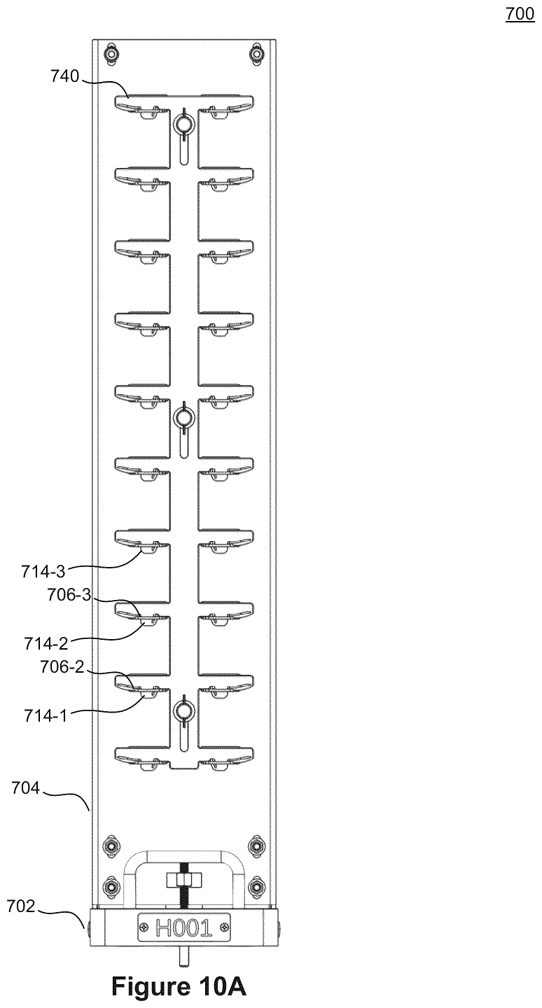

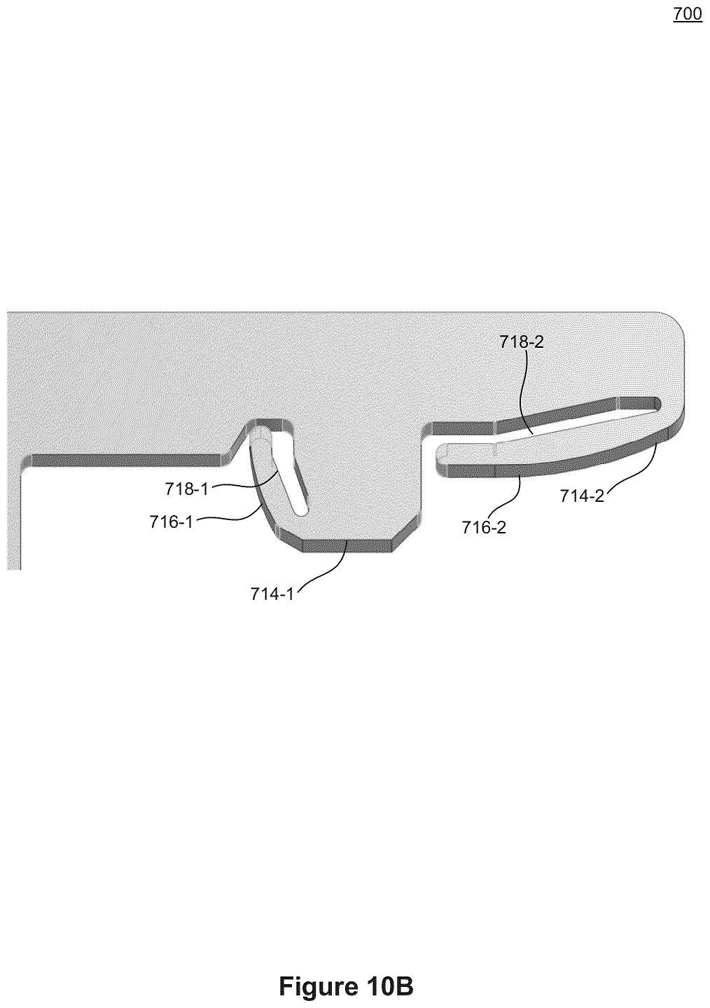

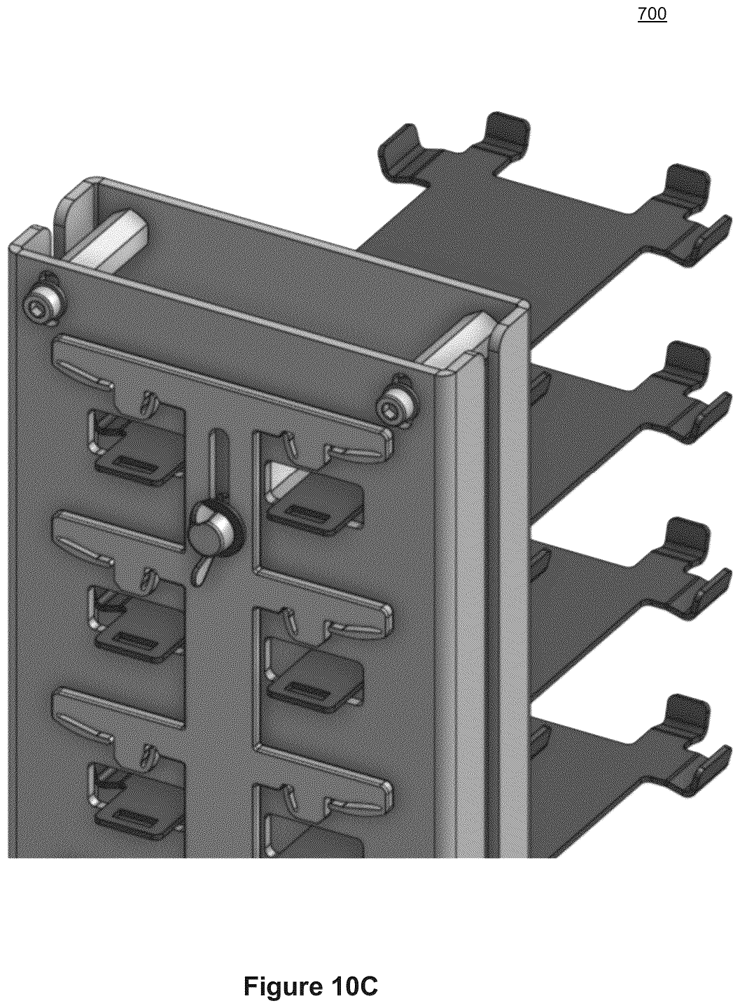

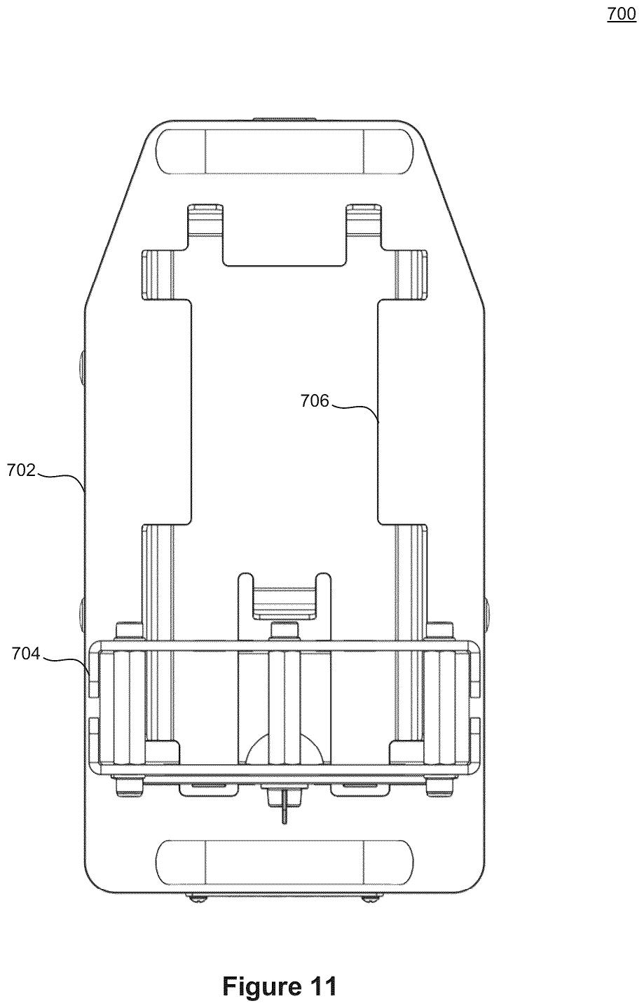

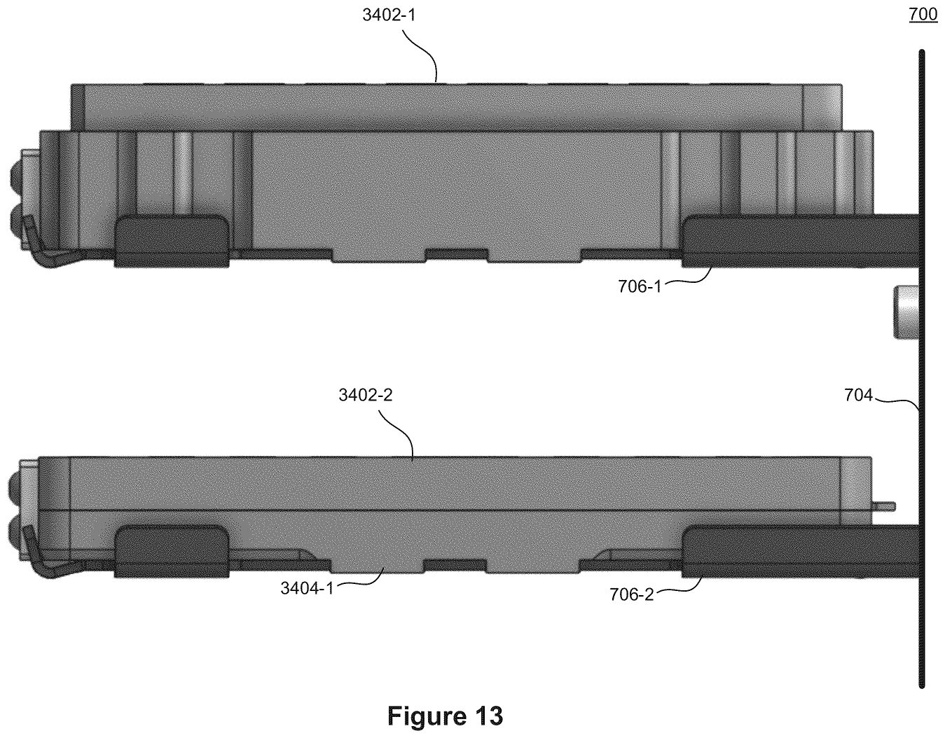

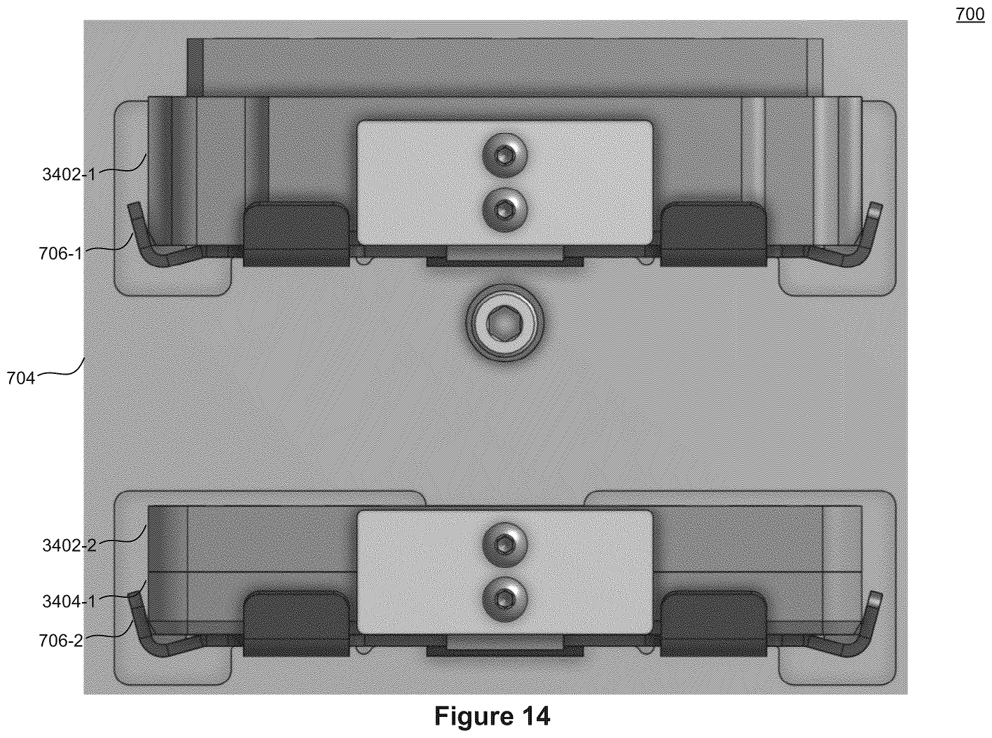

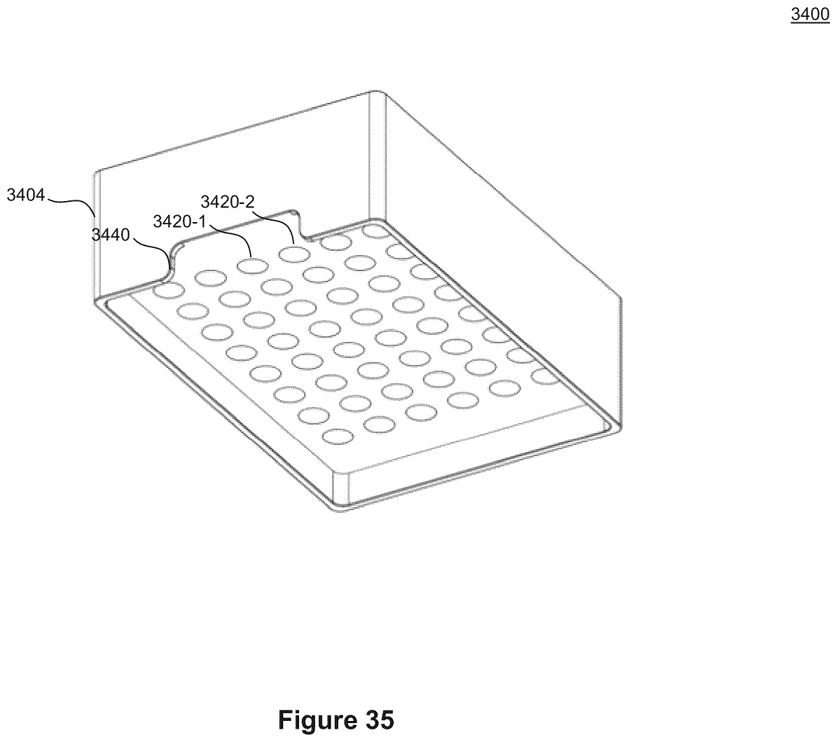

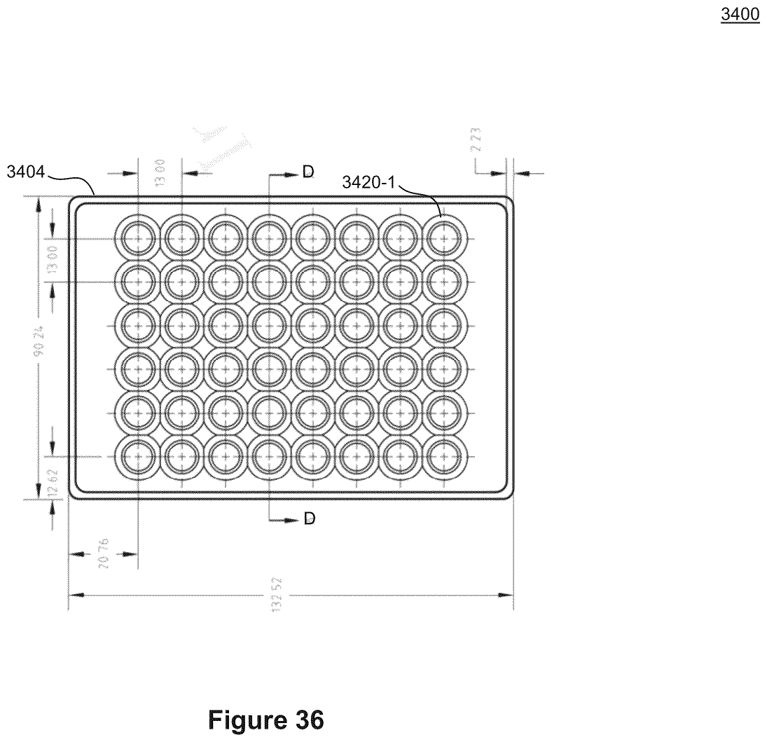

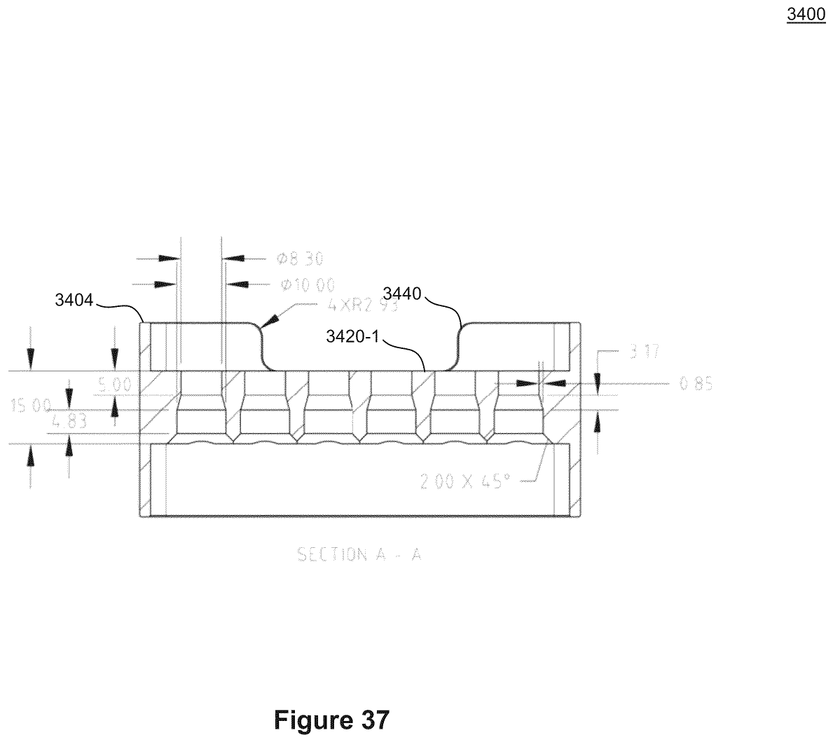

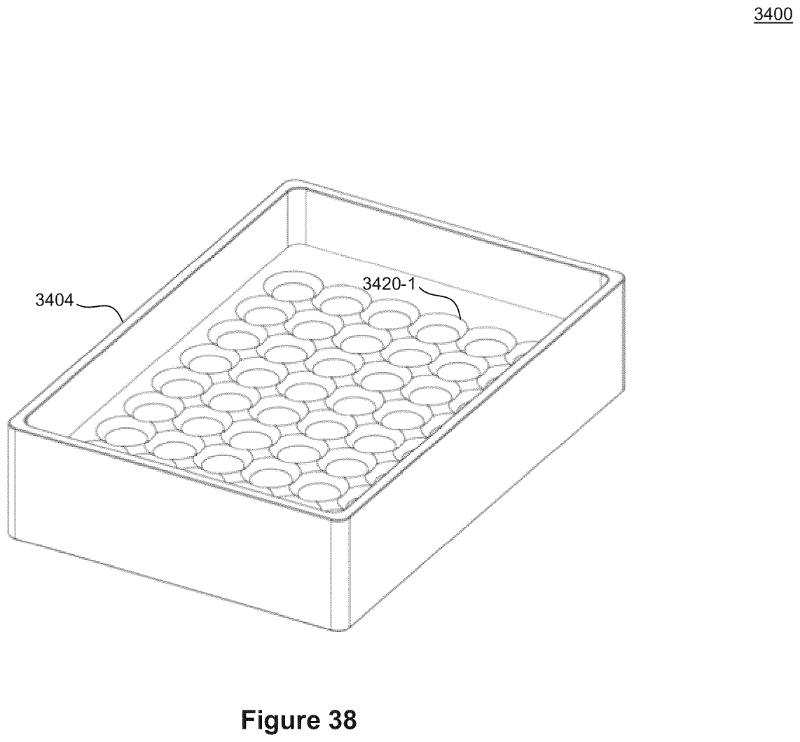

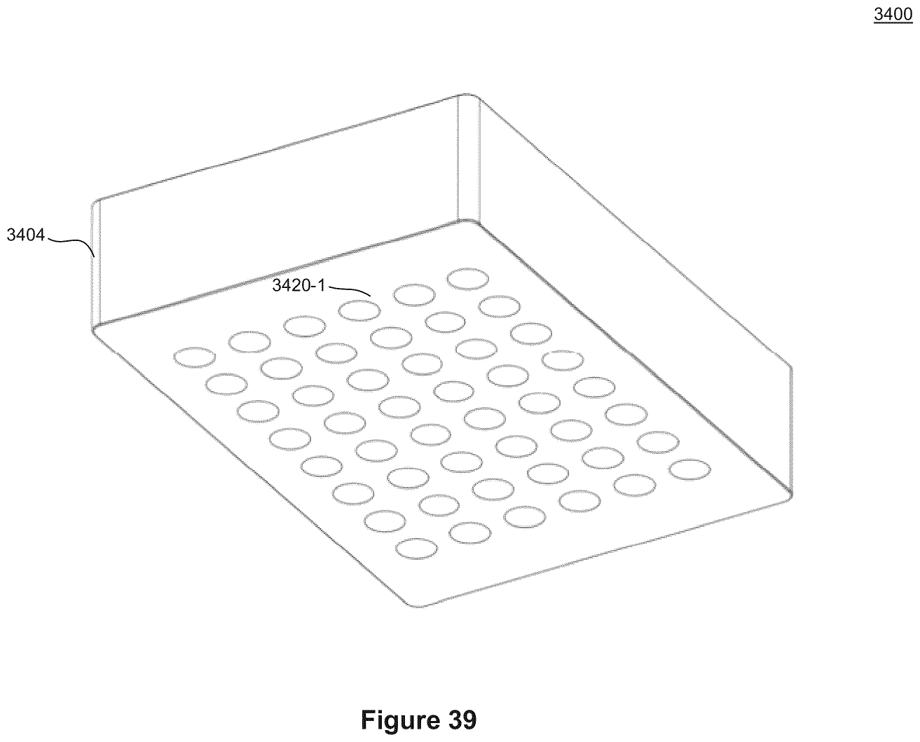

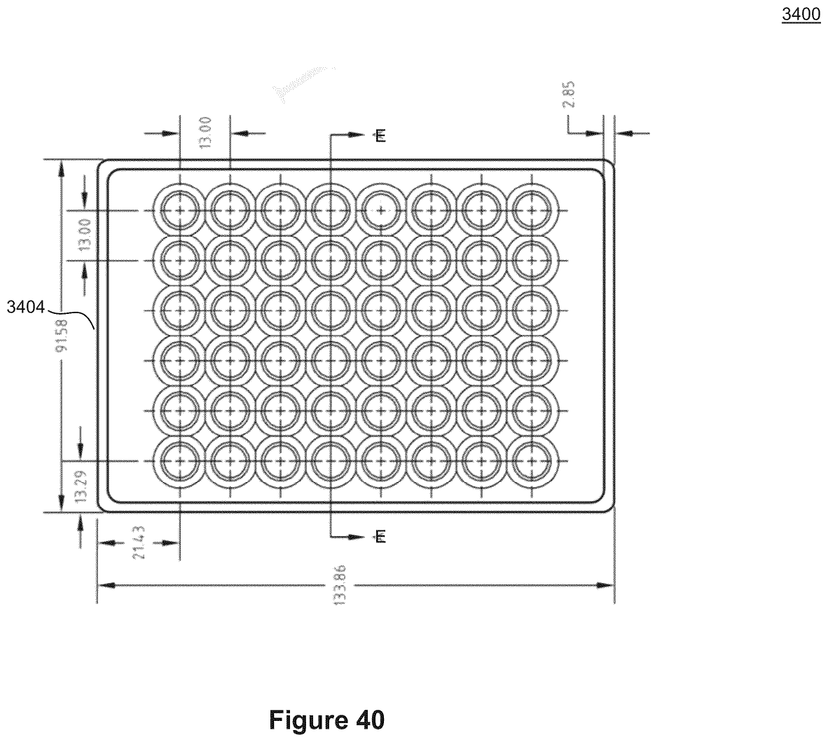

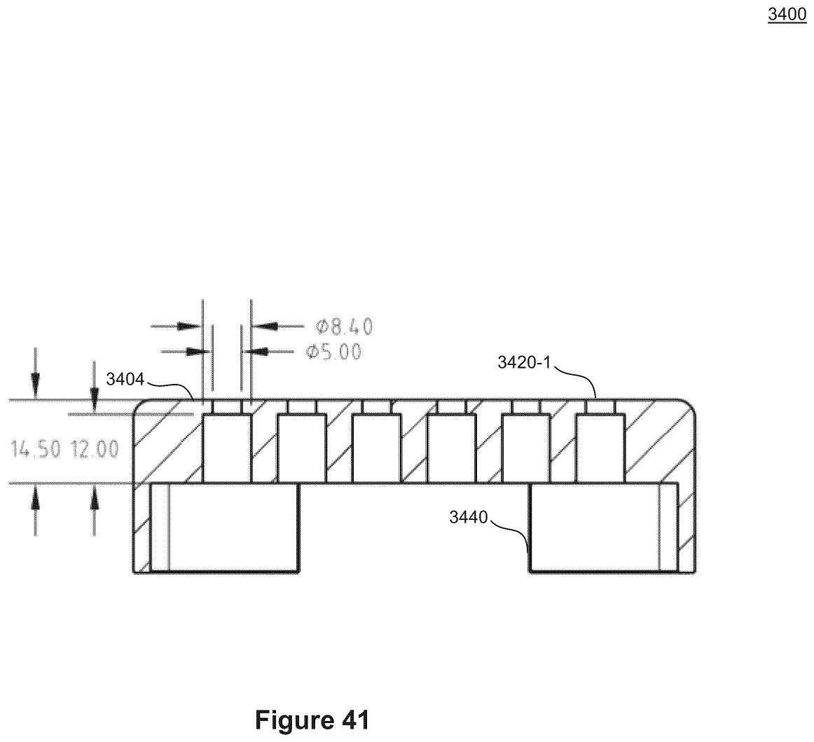

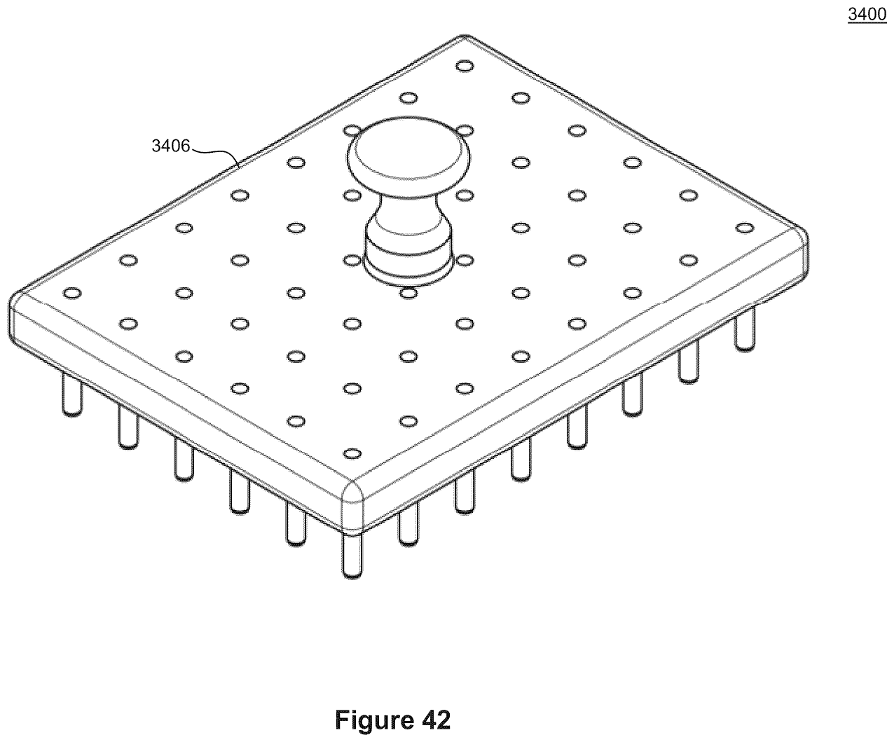

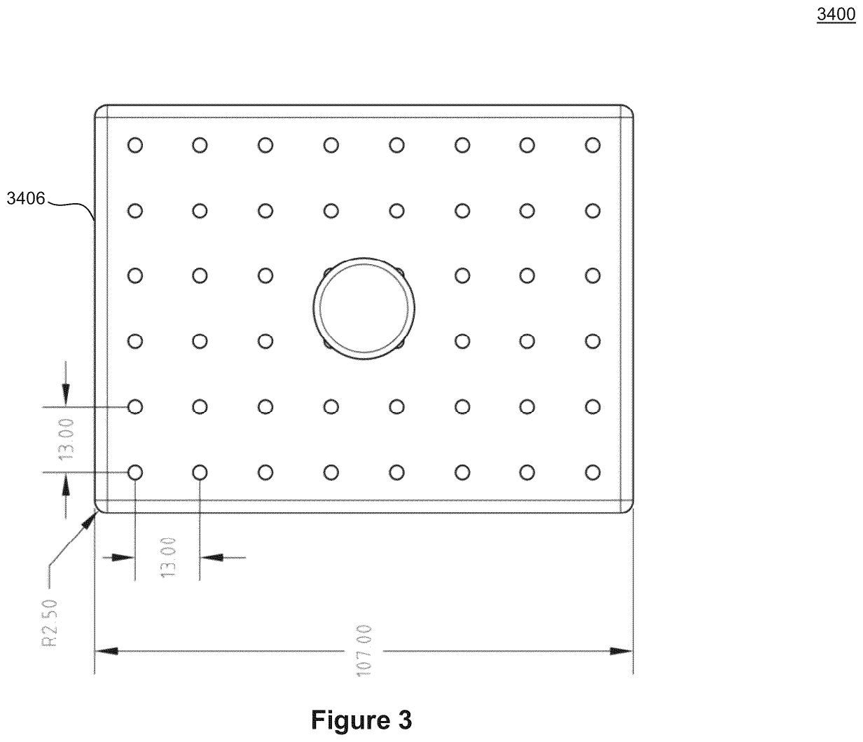

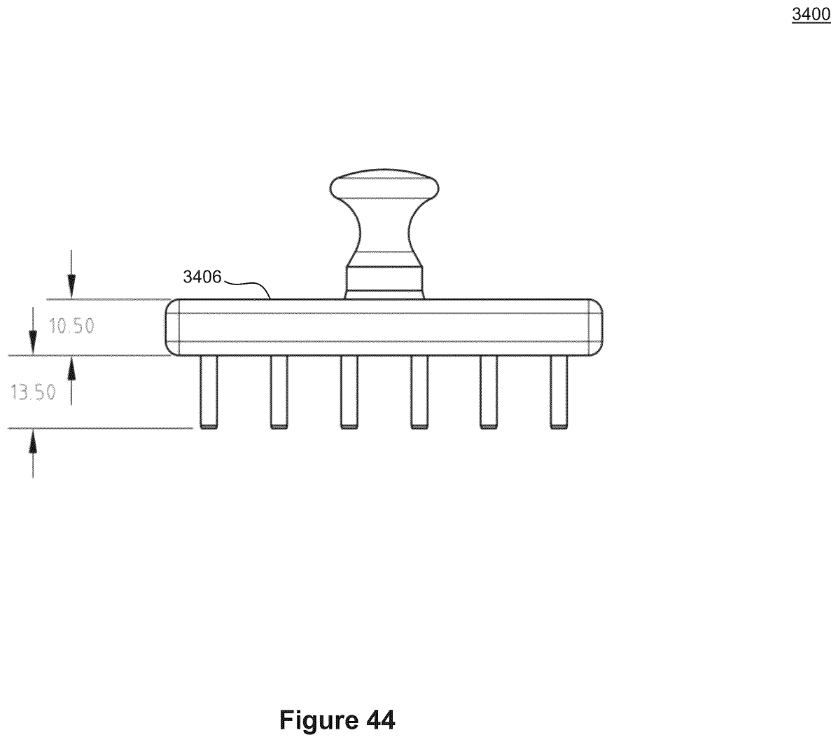

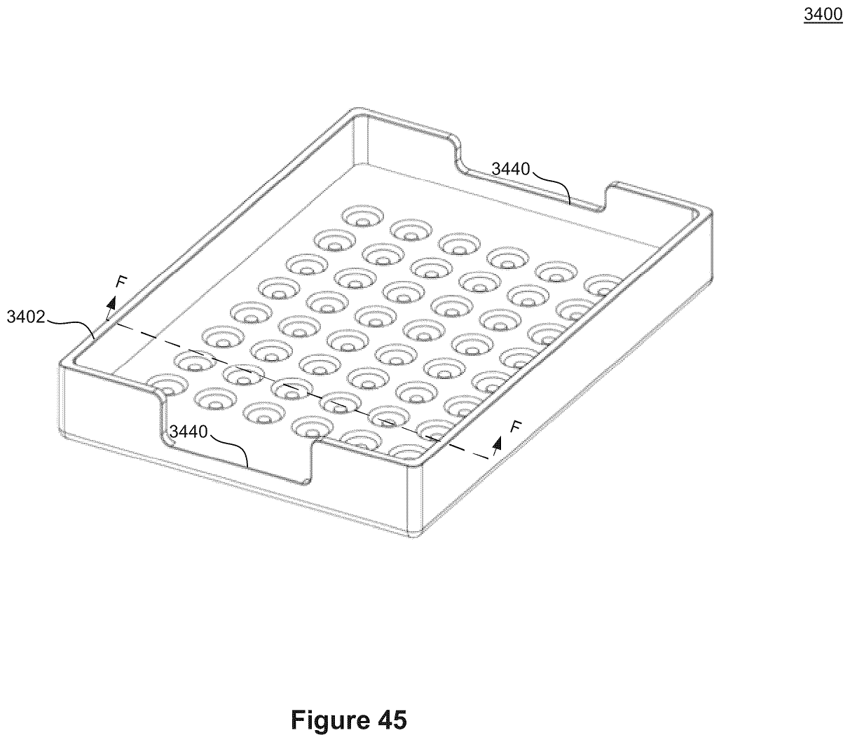

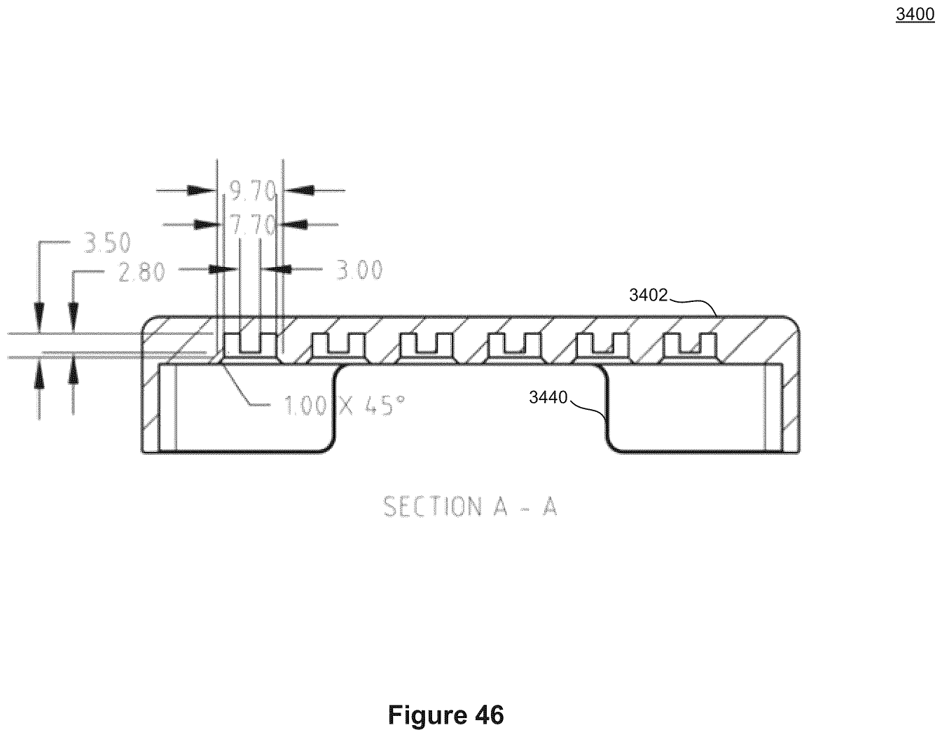

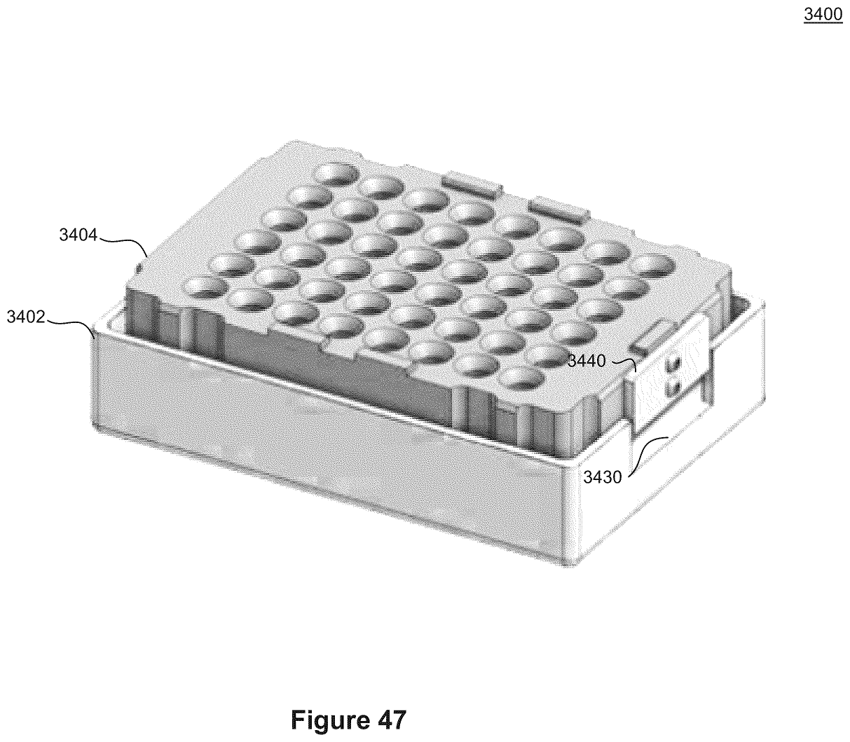

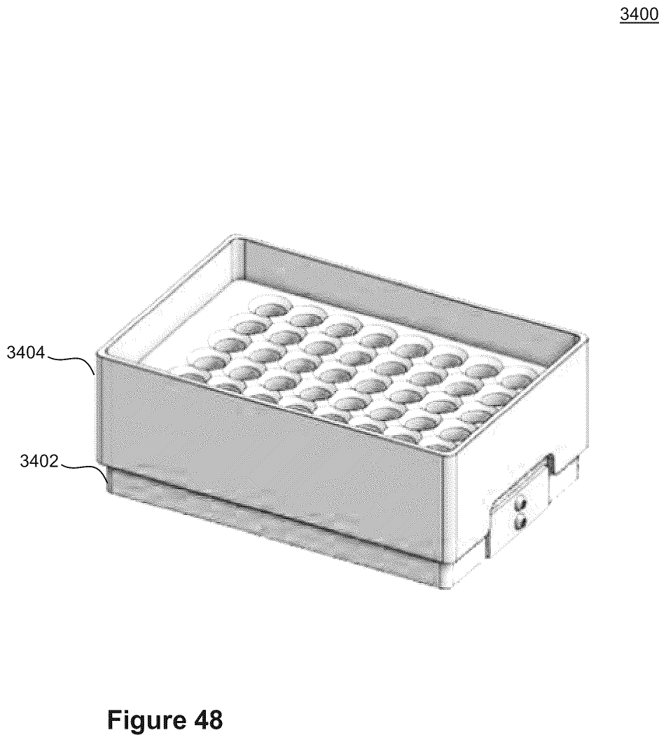

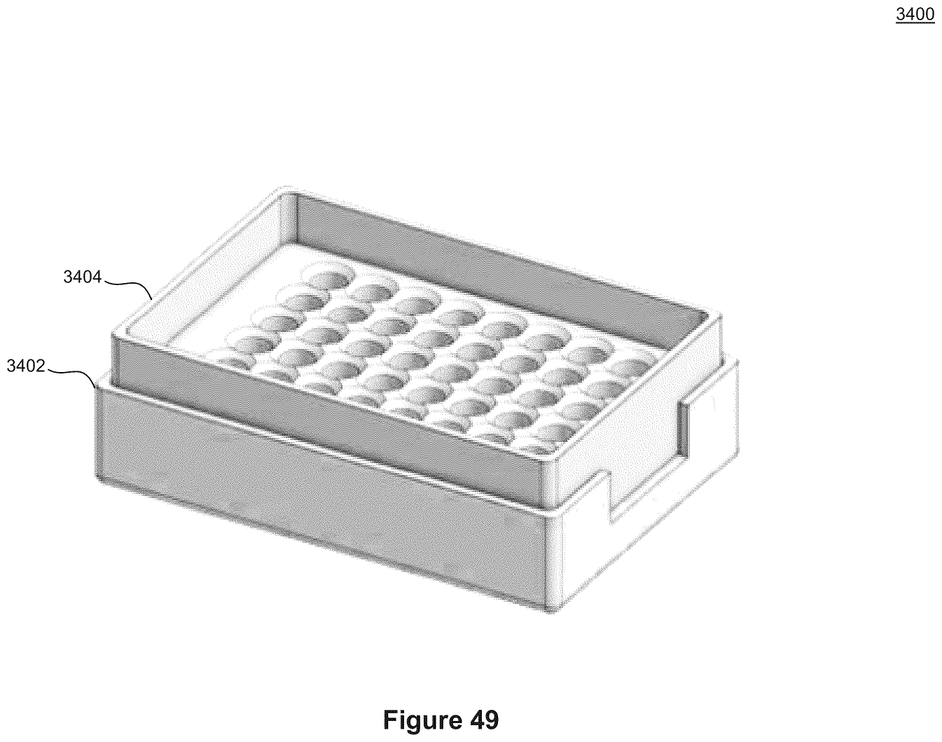

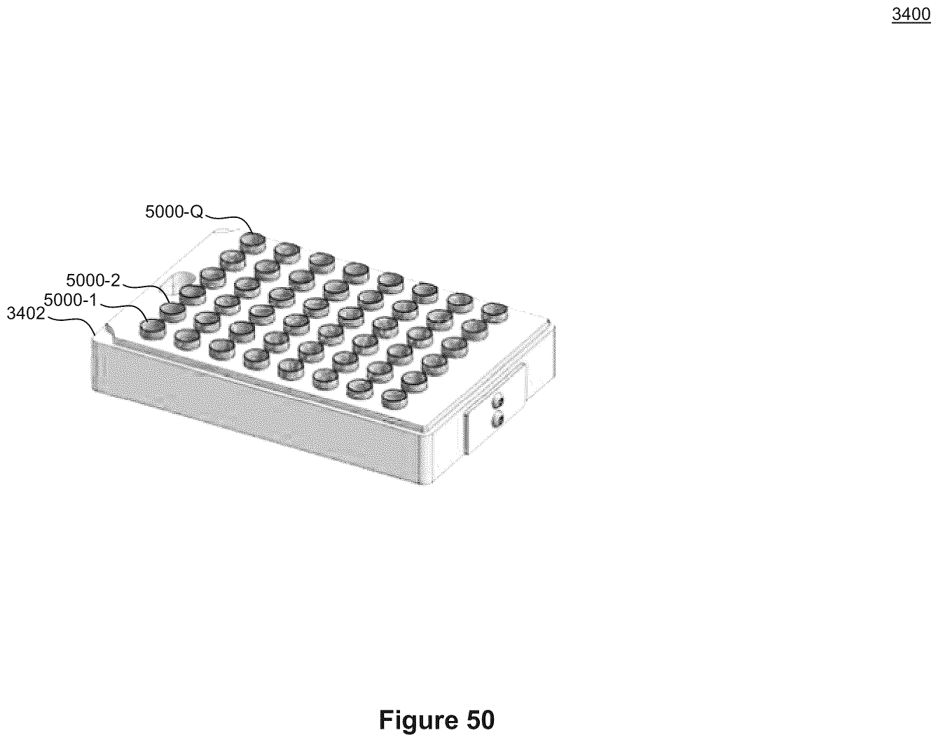

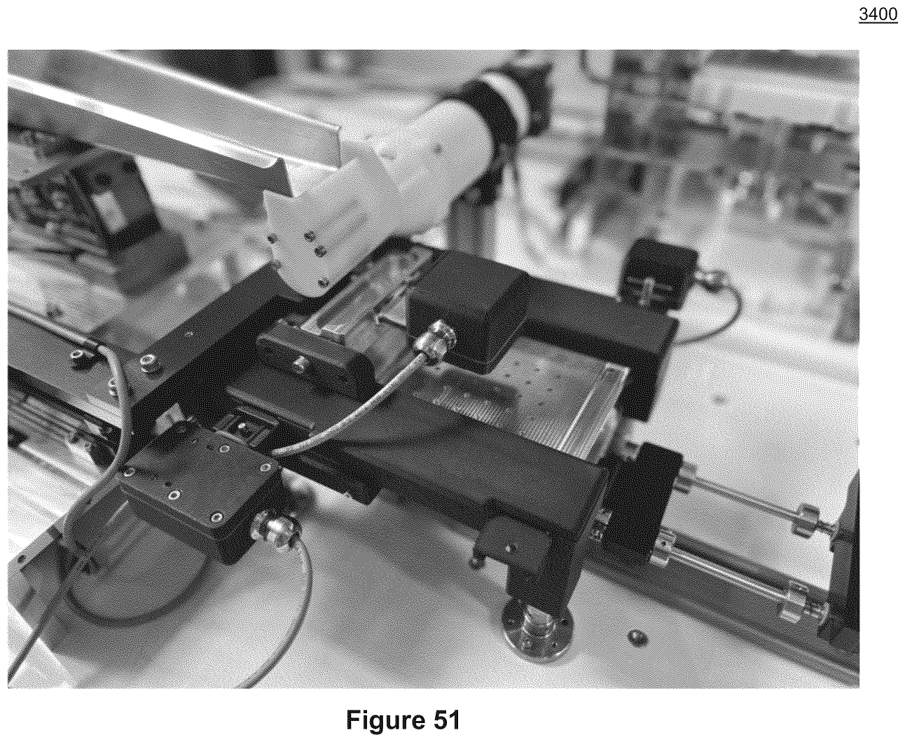

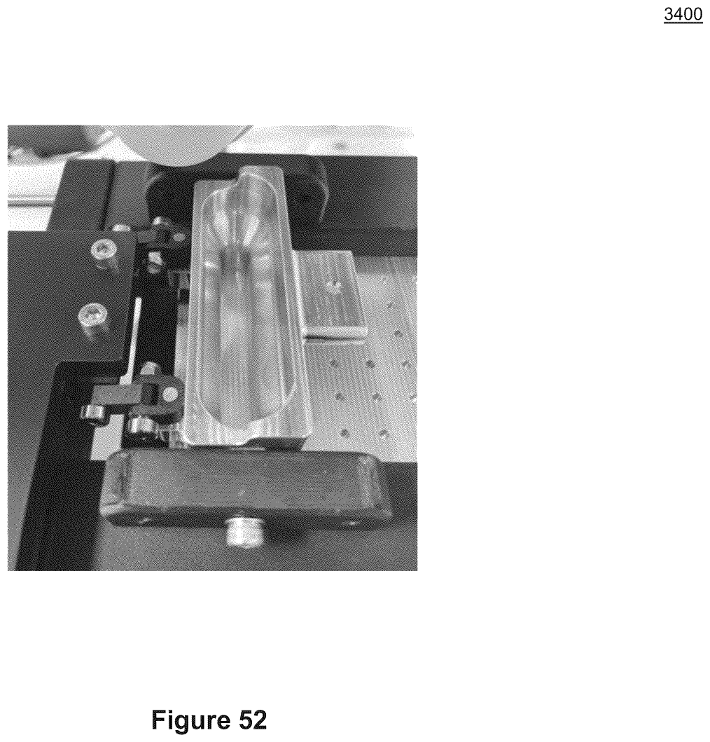

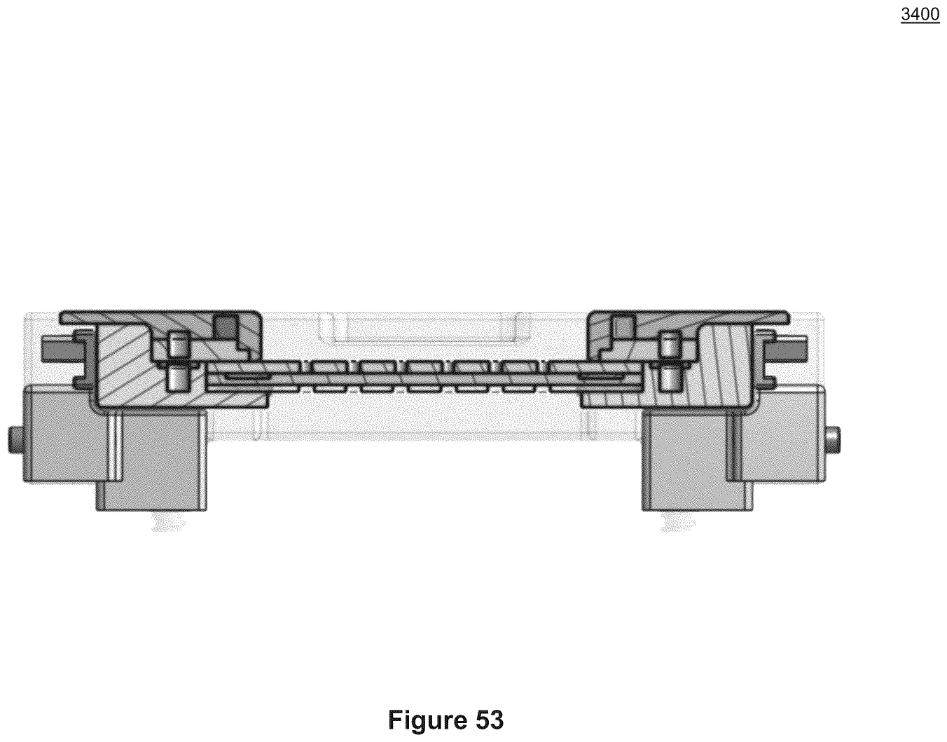

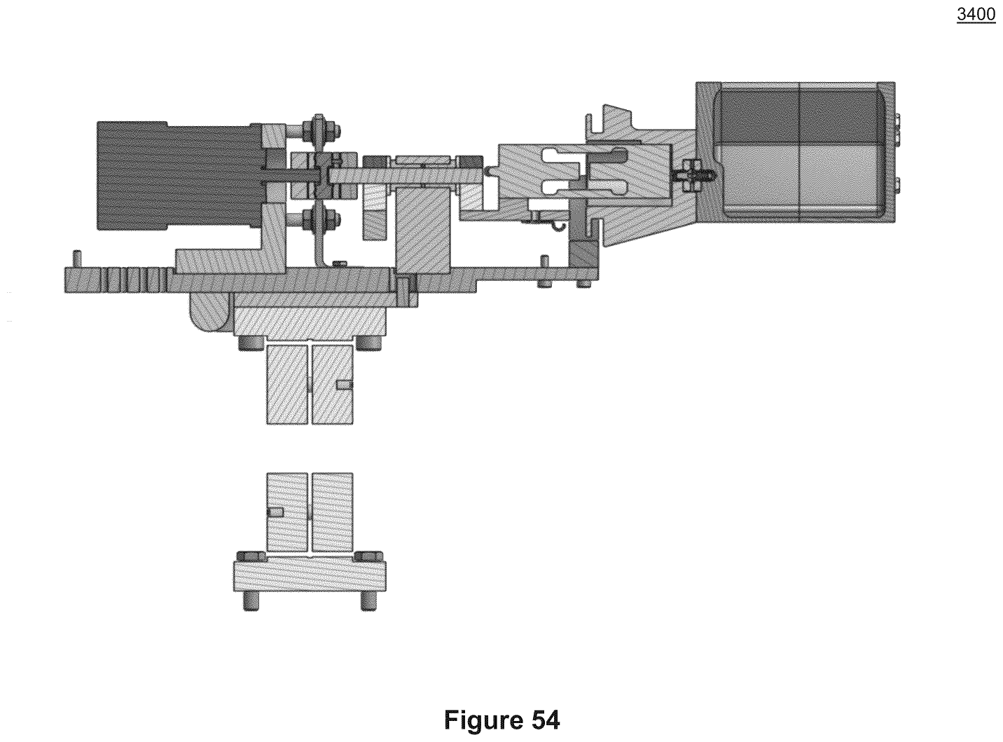

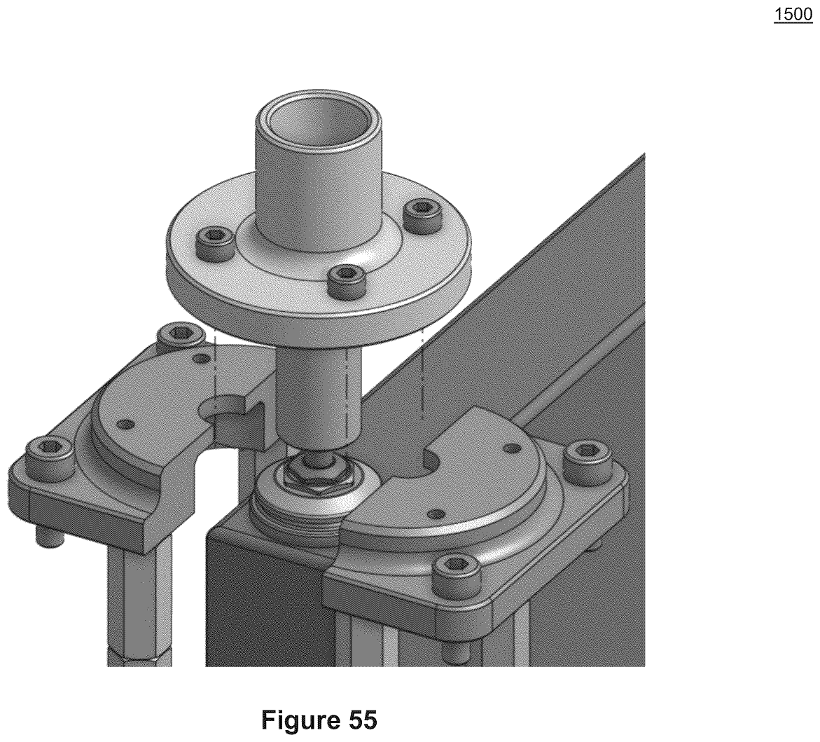

FIGS. 7-14 and FIGS. 34-50 illustrate a docking apparatuses 700 and funnel apparatuses 3400 in accordance with some embodiments of the present disclosure.

In some embodiments, the docking apparatus 700 includes one or more support surfaces 706 and an engagement surfaces 708 or one or more engagement surfaces in a plurality of engagement surfaces extending from a respective support surface 706 or cach support surface accommodated by the spine 704. In some embodiments, the engagement surfaces 706 or one or more engagement surfaces respective engagement surface 708 is configured to engage with a surface of a funnel apparatus 3400, such as a lower surface and/or a side surface of the funnel apparatus 3400 to accommodate the funnel apparatus at the docking apparatus 700. For instance, in some embodiments, the engagement surfaces 706 or one or more engagement surfaces respective engagement surface 708 protrudes upwardly from a substantially planar upper support surface 706 removably coupled to a spine 704 and/or a base 702 of the docking apparatus 700. In some embodiments, the spine 704 allows a first support surface 706 of a first size and a second support surface 706 of a second size different from the first size to be received and accommodated by the spine, which allows for using different size support surfaces simultaneously with the spine 704.

In some embodiments, the base 702 of the docking apparatus is configured to provide rigidity and support for the docking apparatus 700 when the one or more support surfaces 706 engage with or disengage from the spine 704. In some embodiments, the base 702 and the spine 704 removably couple through a fastener, such as a male-female fastener or the like, which allows for the base 702 to remain stationary. For instance, in some embodiments, the base 702 coupled to a surface through a bar and a ball (e.g., spring) plungers that engages with the bar to hold the base 702 stationary. However, the present disclosure is not limited thereto. In some embodiments, the base 702 is configured to provide substantial increase in rigidity of the spine 704 and the support surfaces 706 accommodated by the spine 704. However, the present disclosure is not limited thereto. In some embodiments, the base 702 is configured to provide significant increase in rigidity, incorporation of a concealed fastener, and integration of a simple leveling adjustment for the docking apparatus 700. However, the present disclosure is not limited thereto. In some embodiments, the base 702 is configured to slide onto a surface that includes a corresponding fastener until the base 702 reaches an end stop, which allows for the fastener (e.g., spring plungers) to engage, such as with specifically located divot holes to lock the base 702 into position. However, the present disclosure is not limited thereto.

In some embodiments, the spine 704 includes a self-centering configuration, which allows the support surfaces 706 to self-center when accommodated by the spine 704. For instance, in some embodiments, the spine 704 includes a combination of steep bend angle and displaced radius bend openings, which allow for receiving and engaging with the connectors 714 of the support surface 706. However, the present disclosure is not limited thereto.

In some embodiments, the spine 704 is removably coupled to the base 702 and leveled with a horizontal, such that the support surface provides a substantially horizontal planar surface to accommodate the funnel apparatus 3400.

In some embodiments, by using the connector 714, the position of the support surface 706 is self-aligned even if an articulated robot 202 deposits the support surface 706 on the spine 706 off-center. Accordingly, when there is a positioning error in the placement of the support surface 706, connectors 714 one side of the support surface 706 would be more compressed than the other connectors on an opposing side of the support surface 706. From this, these compressed connectors would push the support surface 706 with more force, moving the support surface 706 towards a center of the spine 704, until the force exerted by the connector 714 is balanced. This passive load-balancing process ensures that the support surface 706 is self-aligning, in that the connector 714 always pushes support surface 706 deposited into the spine 407 towards a center of the spine 407, such as a central axis or a center of the spine 407. As a result, the docking apparatus autonomously (and passively) eliminates any positioning error that might be resulting from the motion of the articulated handling robot.

Another advantage of the docking apparatus of the present disclosure is that the connectors 714 push against a sidewall of the opening of the support surface 706. This way, the connectors 714 also exert forces along directions that are perpendicular to gravity. Therefore, the support surface 706 is secured in place until the support surface 706 is taken from the spine 407 by the articulated handling robot. The additional forces exerted by connectors 714 on the support surface 706 are robust to vibrational forces and to external forces that are not in the direction of gravity. Moreover, since the connectors 714 provide passive engagement members that do not require any external power (e.g., mechanical power and/or electrical power), nor an active control system(s), the docking apparatus is fault-tolerant and keeps the support surface 706 received by the spine 704 in place even in case of a power outage.

In some embodiments, the connector 714 is disposed along a perimeter (e.g., contour) of an upper end portion and/or side portion of the support surface 706. In some embodiments, the connector 714 has a uniform shape. Additionally, in some embodiments, the connector 714 is removably coupled to the spine 704. Additional connectors 714 will result into a stronger gripping force exerted on the support surface 706. Moreover, using a plurality of the connectors 714 allows the docking apparatus to adapt to any shape of the support surface 706. For instance, in some embodiments, the connector 714 is configured such that the docking apparatus is suitable for receiving an instrument that has a prismatic shape, such as an instrument including a substantially planar base of any shaped support surface 706. However, the present disclosure is not limited thereto. For instance, in some embodiments, the connector 714 allows for receiving the support surface 706 having a complex shape, which is completely secured in the spine 407 by the connectors 714.

In some embodiments, the connector 714 deforms when a rigid cartridge is inserted, keeping the one or more trays in place and aligning a position of the one or more trays based on corresponding positions of the connector 714, such as automatically and passively centering the tray on a substantially planar upper surface of a base of the docking station. Moreover, since the connector 714 is designed to operate in an elastic region of a material of the connector 714, the connector 714 tolerates a very high number of cycles of engaging with the support surface 706.

In some embodiments, the docking apparatus 700 is configured to store between 2 and 50 support surfaces 706, between 3 and 20 support surfaces 706, between 5 and 15 support surfaces 706, or between 7 and 14 support surfaces 706. In some embodiments, the docking apparatus 700 is configured to store at least 2 support surfaces 706, at least 3 support surfaces 706, at least 6 support surfaces 706, at least 10 support surfaces 706, at least 15 support surfaces 706, at least 20 support surfaces 706, at least 25 support surfaces 706, or at least 50 support surfaces 706. In some embodiments, the docking apparatus 700 is configured to store at most 2 support surfaces 706, at most 3 support surfaces 706, at most 6 support surfaces 706, at most 10 support surfaces 706, at most 15 support surfaces 706, at most 20 support surfaces 706, at most 25 support surfaces 706, or at most 50 support surfaces 706. In some embodiments, this allows the articulated handling robot to pick one or more support surfaces 706 (e.g., disengaging connectors from spine) when needed. In some embodiments, one or more edge portions of the support surfaces 706 include a chamfer that uses gravity to favor the correct alignment of the tray after the funnel apparatus 3400 is disposed on the support surfaces 706. However, the present disclosure is not limited thereto.

In some embodiments, a support surface 706 or one or more support surfaces 706 is accommodated by the spine 704 via an opening, or slot, on a surface of the spine 704. In some embodiments, the opening of the spine 704 includes a protrusion, such as a tab, which protrudes towards a center of the opening formed by the slot. In some embodiments, the spine 704 includes two or more openings, or slots, on the surface of the spine that align or substantially align, in order to provide a horizontal tolerance when accommodating the support surface. In some embodiments, the protrusion is formed at a bottom end portion of the slot or opening and extends upwardly towards the center of the opening formed by the slot. However, the present disclosure is not limited thereto.

In some embodiments, a height of an edge portion of the engagement surface 708 protruding from the support surface 706 is uniform (e.g., the same height), which allows for the engagement surface 708 to not interfere with a different engagement surface 708 and further engage a unique surface (e.g., a unique surface of a different funnel apparatus 3400). In some embodiments, the engagement surface 708 includes a fixed body protruding upwardly from the support surface 706. Moreover, in some embodiments, the engagement surface 708 includes a spring integrally formed with the engagement surface 708 and extending upwardly from an end portion of the support surface 706. From this, a deformable gap is formed interposing between engagement surface 708 and the support surface 706. In some embodiments, the engagement surface 708 includes a radius of curvature greater than zero at an edge portion or a corner portion of the engagement surface and/or the support surface, which allows the engagement surface and/or the support surface to bend when accommodating a load, such as a funnel apparatus of the present disclosure. However, the present disclosure is not limited thereto. In some embodiments, the support surface includes a first engagement surface that opposes a second engagement surface of the support surface, which allows for the support surface to self-center with a body accommodated by the support surface based on the bend angle of the engagement surface and displaced radius due to bending of the engagement surface. However, the present disclosure is not limited thereto. In some embodiments, the support surface includes a first pair of opposing engagement surfaces at a first edge portion and a second edge portion of the support surface. In some embodiments, the support surface includes a second pair of opposing engagement surfaces at a second edge portion and a third edge portion of the support surface. In some embodiments, the first pair of opposing engagement surfaces is perpendicular to the second pair of opposing engagement surfaces.

In some embodiments, an edge portion of the support surface 706 includes one or more connectors 714 that allow the support surface 706 to removably couple to the spine 704 of the docking apparatus 700. For instance, in some embodiments, the connector 714 includes one or more protrusions extending substantially parallel to a planar surface of the support surface 706. In some embodiments, the one or more protrusions 716 forming a gap 718 that acts as a spring integrally formed with the connector 714, such as a spring that provides action oblique to the substantially planar upper surface of support surface 706. However, the present disclosure is not limited thereto. From this, a deformable gap 718 is formed interposing between a surface of the fixed body and a lower end surface of the spring. Accordingly, the connector 714 is configured to engage a surface of the spine 704, such as one or more openings and/or one or groves formed on an exterior surface of the spine 704, and removably couple the support surface 706 and the docking apparatus 700 together through the spring action provided by the protrusion 716 and the gap 718. In some embodiments, the spring action is achieved with the protrusions 716 that deform the support surface 706 is inserted into an opening of the spine 704, keeping the support surface 706 in place and aligning a position of the support surface 706 based on corresponding positions of the connectors 714 and the spine 704, such as automatically and passively centering the support surface 706 on the spine 704 of the docking apparatus 700. In some embodiments, since these connectors 714 are clastic and passive, they are extremely robust and do not require special maintenance to function properly. Moreover, since the connectors 714 are designed to operate in an elastic region of a material of the connectors 714, the connectors 714 tolerate a very high number of cycles of engaging with the spring 704. Furthermore, through the spring action of the connectors 714, different sized support surfaces 706 can be accommodated by the docking apparatus 700 without having to reconfigure the spine 704. In some embodiments, the support surface 706 includes at least two connectors 714, at least three connectors 714, or at least connectors 714. For instance, in some embodiments, the support surface 706 includes at least a first connector 714-1 that is configured to prevent translational motion in a first direction (e.g., (horizontal motion) of the support surface 706. In some embodiments, the support surface 706 includes at least a second connector 714-2 that is configured to prevent tolerance effects and translational motion in a second direction (e.g., vertical motion) perpendicular to the first direction. Furthermore, in some embodiments, the connectors 714 allow for self-leveling of the support surface 706 with the base of the apparatus. However, the present disclosure is not limited thereto. In some embodiments, the docking apparatus 700 includes a second spine 740 that includes one or more connectors 714. In some embodiments, the one or more connectors 714 of the second spine 740 is configured to be accommodated by a slot or opening disposed on the support surface 706. Accordingly, in some embodiments, the support surface 706 is supported in a vertical direction by the one or more openings of the first spine 704 and supported in a horizontal direction by the one or more connectors 714 of the second spine 740. In some embodiments, the support surface 706 is restricted from moving in a vertical direction by the one or more openings of the first spine 704 (e.g., possesses no vertical translational freedom) and restricted from moving in a horizontal direction by the one or more connectors 714 of the second spine 740 (e.g., possesses no horizontal translational freedom). In this way, in some embodiments, the support surface is easily disposed on the spine 704 and level with the base 702 based on the openings of the spine 704 and coupled to the spine 704 by the connectors 714 of the second spine, which locks the position of the support surface 706 on the spine 704 and prevents unwanted free motion of the support surface 706. However, the present disclosure is not limited thereto.

In some embodiments, the planar surface of the support surface 706 allows for accommodating the funnel apparatus 3400 without causing instability or damage to the funnel apparatus. In some embodiments, the planar surface of the support surface 706 provides an ergonomic feature for positioning and accessing the funnel apparatus. However, the present disclosure is not limited thereto.

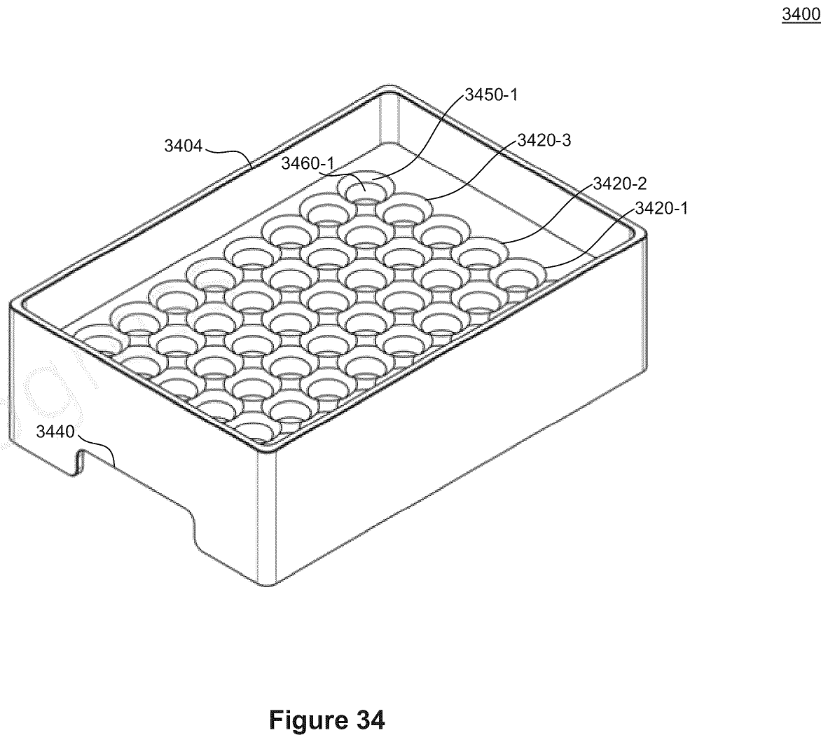

FIGS. 34-50 illustrate funnel apparatuses 3400 in accordance with some embodiments of the present disclosure. In some embodiments, the funnel apparatus 3400 includes a base 3402 and one or more trays 3404 that is accommodated by the base 3402.

The base 3402 includes an opening 3410 or one or more openings a plurality of openings 3410 disposed on a first surface of the base 3402. In some embodiments, the opening 3410 or one or more openings in the plurality of openings 3410 is configured to receive a body, such as a capsule body, a capsule divider, and a capsule cap. In some embodiments, the opening 3410 or one or more openings in the plurality of openings 3410 is individually spaced at a predetermined interval along a dimension of the base 3402. In some embodiments, the predetermined interval is defined by a spacing between adjacent through holes 3420 of the base 3402. However, the present disclosure is not limited thereto.

In some embodiments, differences in function between the base 3402 and the trays 3404 is seen by comparing respective cross-section views. For instance, in some embodiments, the opening 3410 or one or more openings in the plurality of openings 3410 includes a second size at a first end portion of the tray 3404 and a third size at a second end portion of the tray 3404. For instance, in some embodiments, the first end portion is an upper end portion of the tray 3404, the second portion is a lower end portion of the tray 3404, and the first size is greater than the second size. However, the present disclosure is not limited thereto. For instance, in some embodiments, the first end portion is the upper end portion of the tray 3404, the second portion is the lower end portion of the tray 3404, and the first size is less than the second size. In some embodiments, a through-hole or one or more through holes in the plurality of through holes 3420 and/or an opening or one or more openings in the plurality of openings 3410 is arranged in a matrix having M rows and N columns. As a non-limiting example, M is about 6 and N is about 8.

Moreover, the second surface of the base 3402 is substantially perpendicular to the first surface, which allows for tray 3404 to be accommodated by the base 3402. For instance, in some embodiments, an angle formed between the first surface and the second surface of the base 3402 allows for specific positioning of the tray 3404 when accommodated by the base 3042. In some embodiments, the first surface and/or the second surface is planar or substantially planar, which allows for receiving the base in a stable configuration, such that there is little to horizontal movement between the tray and the base when coupled together. However, the present disclosure is not limited thereto. In some embodiments, the second surface of the base 3402 further includes a connecting member 3430 disposed on the second surface. Additionally, a fourth surface of the tray 3404 is substantially perpendicular to the third surface, which allows for seating or accommodating the base or another tray via the fourth surface and the second surface of the tray. In some embodiments, the fourth surface further includes a mating member 3440 for receiving the connecting member 3430 of the base 3402. For instance, in some embodiments, the mating member and/or the connecting member includes a pin, a socket, a blade, a receptible, a bolt, a nut, a screw, a hole, a spline, a key, a tongue, a groove, a ball, a clip, a groove, or a combination thereof.

In some embodiments, a surface of the tray includes a two-or three-dimensional mating member 3440 that corresponds to the connecting member 3430 of the base 3402. For instance, in some embodiments, the mating member 3440 includes one or more protrusions, one or more grooves, one or more openings, one or more impressions, one or more ridges, or a combination thereof that engage with the connecting member 3430. In some embodiments, the mating member 3440 includes an opening that extends from a surface of the base 3042 including an opening or through hole. In some embodiments, the opening of the mating member allows for discharge of the body 5000 from the apparatus. However, the present disclosure is not limited thereto.

In some embodiments, the load box has a raised platform for the funnels to shake and load capsules and dividers. However, the present disclosure is not limited thereto.

Furthermore, the funnel apparatus includes a tray including a third surface. In some embodiments, the third surface includes a through-hole or one or more through-holes in a plurality of through-holes. In some embodiments, the through hole or one or more through holes in the plurality of through holes with a corresponding opening of the base, which allows for receiving a body from the base and/or disposing the body into the base. However, the present disclosure is not limited thereto.

Accordingly, in some embodiments, cach open capsule body 5000 is accommodated (e.g., aligned) within an opening 3410, such as with an open end facing in an upward. As described supra, in some embodiments, the capsule assembly apparatus includes three different types of tray 900, such that each body component of a capsule structure has a corresponding tray type. In some embodiments, each type of tray is configured to only carry a corresponding capsule component that a respective tray is configured to accommodate. In some embodiments, the body tray is configured to accommodate a plurality of capsule bodies. In some embodiments, the divider tray is configured to accommodate one or more capsule dividers. In some embodiments, the cap tray is configured to accommodate one or more capsule bodies. Accordingly, in some embodiments, the cap tray, the divider tray, and the base tray are designed to accommodate different capsule components, and to allow assembling the capsules by way of the trays 3404 accommodated by the base 3402.

In some embodiments, the base 3402 includes a plurality of openings 3410 that is designed to accommodate and support a corresponding plurality of capsule bodies 5000. In some embodiments, a capsule body 5000 is the longest components of the capsule. On a bottom end portion of cach opening 3410 in the body tray there is a hole of a first length. In some embodiments, the hole is configured to allow a pin of a capsule assembly apparatus to push the capsule body into the capsule cap in a step of the capsule assembly process.

In some embodiments, cach opening in the plurality of openings and/or cach through-hole in the plurality of through-holes includes a rounded edge portion, a chamfer edge portion, a beveled edge portion, or a combination thereof. In some embodiments, cach opening in the plurality of openings and/or cach through-hole in the plurality of through-holes includes a first chamfer 3450 and a second chamfer 3460. In some embodiments, the first chamfer 3450 extends about a periphery of the respective opening or the respective through-hole. In some embodiments, the first chamfer 3450 extends about some or all of the periphery. In some embodiments, the second chamfer 3460 extends about a periphery of the first chamfer 3450 and a side-wall of the respective opening or the respective through-hole. For instance, in some embodiments, the first chamfer allows for the capsule body to easy fall into a hole or opening but having a first diameter that is greater than a second diameter of the second chamfer and a third diameter of the capsule body 5000. In some embodiments, a first length of the first chamfer is less than a second length of the second chamfer, which allows for the capsule body 5000 to fall into the opening or through-hole by gravity alone. In some embodiments, a first angle of the first chamfer is less than a second angle of the second chamfer, which allows for the end portion of the capsule body 5000 to align with and locate the opening or hole. Accordingly, in some embodiments, the first chamfer expands entry for the capsule body to casily fall into the opening or through hole by gravity, whereas make capsules very easy to fall to holes, whereas the narrower second chamfer allows for the capsule body to fall through the opening or through-hole with low friction. In some embodiments, the edge portion of each opening and/or each through-hole forms a funnel through the first chamfer and/or the second chamfer. In some embodiments, the funnel provided by the first chamfer and/or the second chamfer is actuated in a horizonal plane (e.g., only x y orientation) in order to promote movement of the capsules into the first chamfer and/or the second chamfer. In some embodiments, a first edge portion (e.g., a first chamfer) is configured to expand a size of an opening (e.g., an entrance) for capsules, which allows for the capsules to fall to a corresponding hole of the opening. However, the present disclosure is not limited thereto. Moreover, in some embodiments, the surface of the base includes a bevel, which allows for a body 500 to roll to a lower end portion of the apparatus, such as a bottom portion, for collection and reuse of the body. However, the present disclosure is not limited thereto. In some embodiments, a length of a chamfer is a depth of the chamfer, such a depth of the first chamfer from an upper end portion to a lower end portion of the first chamfer.

In some embodiments, a second edge portion (e.g., a first chamfer of the Figures) narrows from a first width to a second width greater than the first width, which allows for locating a path of a capsule towards the opening or through-hole. In some embodiments, the base includes one or more through-holes or a plurality of through-holes, in which a hole in the plurality of holes includes a diameter, such as first diameter about 8.3 mm diameter that is configured to allow a capsule including a dimension of about 7.34 mm (e.g., a size zero capsule) to pass through with low or minimal friction.

In some embodiments, one or more openings in the plurality of openings forms a first array, such as a grid or matrix of openings. Moreover, in some embodiments, a center of the first array is offset from a center of the first surface. In some embodiments, the center of the one or more openings is a centroid of each opening on the one or more openings, such as an average or mean position of an origin of each opening in the one or more openings. In some embodiments, the center of the one or more openings is a circumcenter of the one or more openings, an incenter of the one or more openings, an orthocenter of the one or more openings, an excentre of the one or more openings, a center of gravity of the one or more openings, or a combination thereof. In some embodiments, one or more through-holes or the plurality of through-holes forms a second array. Moreover, a center of the second array is offset from a center of the third surface. In some embodiments, the center of the one or more through-holes is a centroid of each through-hole, such as an average or mean position of an origin of each through-hole in the one or more through-holes. In some embodiments, the center of the one or more through-holes is a circumcenter of the one or more through-holes, an incenter of the one or more through-holes, an orthocenter of the one or more through-holes, an excentre of the one or more through-holes, a center of gravity of the one or more through-holes, or a combination thereof.

In some embodiments, the apparatus includes the pin device 3406, in which each pin includes a length configured to push a capsule body downwardly without denting or materially degrading the capsule body. However, the present disclosure is not limited thereto. In some embodiments, the device 3406 refuse the wrong orientation of dividers to go in. In some embodiments, only the concave surface can be seated. However, the present disclosure is not limited thereto.

In some embodiments, the chamfer and the diameter of the opening 3410 and/or through-hole 3420 raise the possibility of the divider going into the opening 3410 and/or through-hole 3420. In some embodiments, the dimensions and diameter of the pin device 3406 and the opening 3410 and/or through-hole 3420 are sized to prevent the body 5000 from getting stuck in the opening or through-hole. However, the present disclosure is not limited thereto.

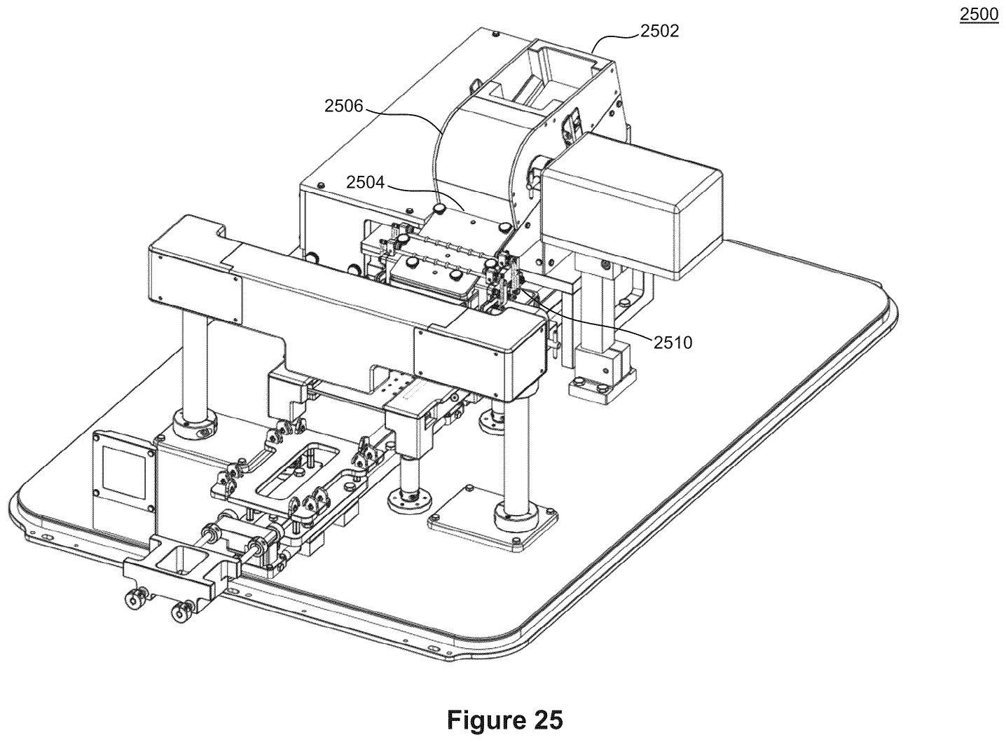

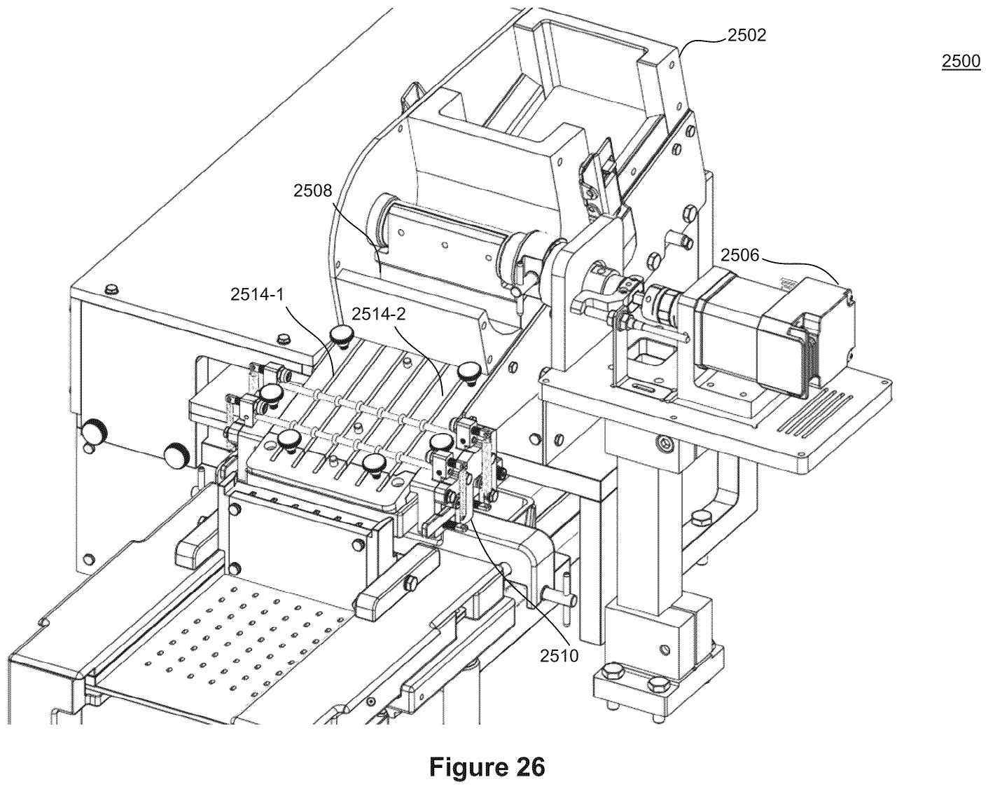

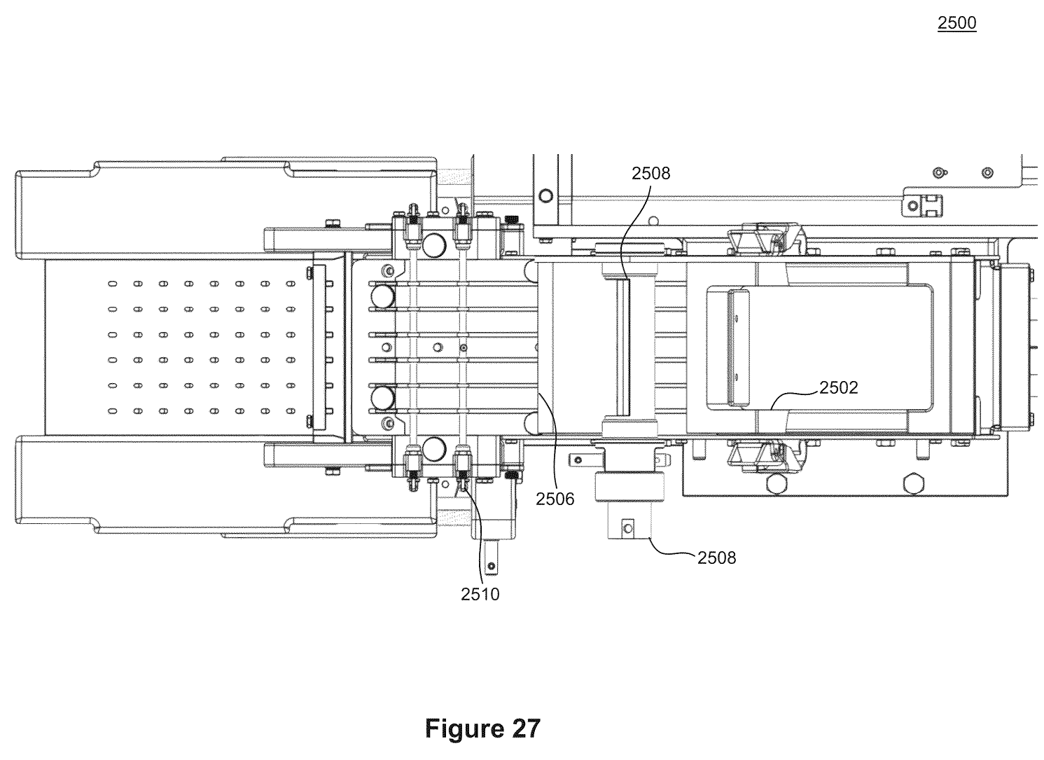

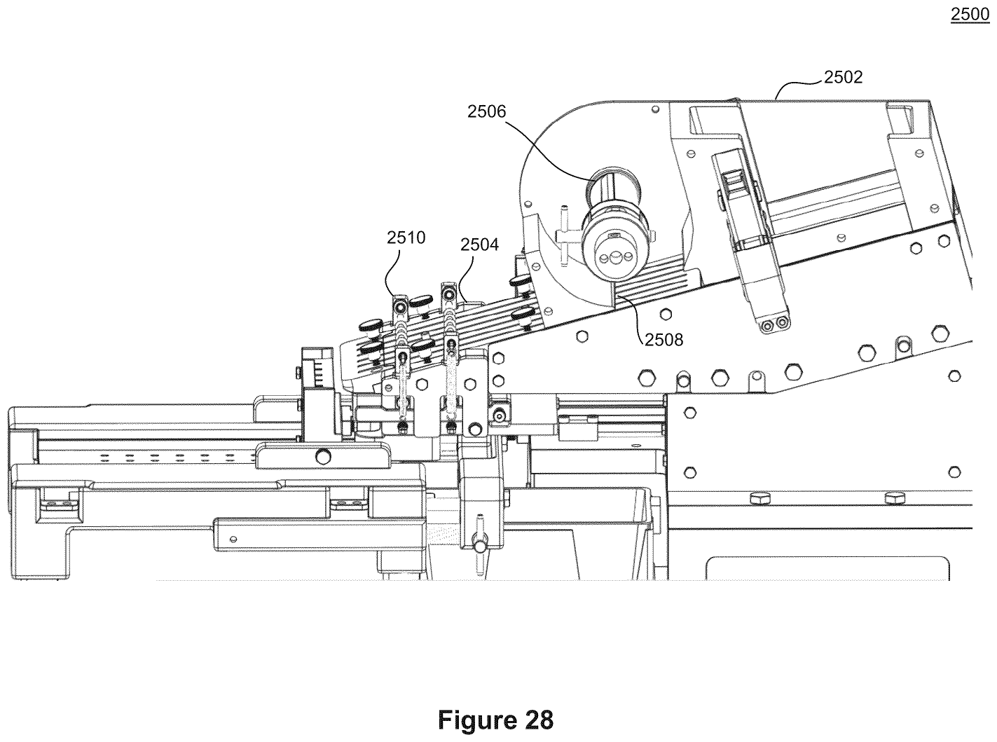

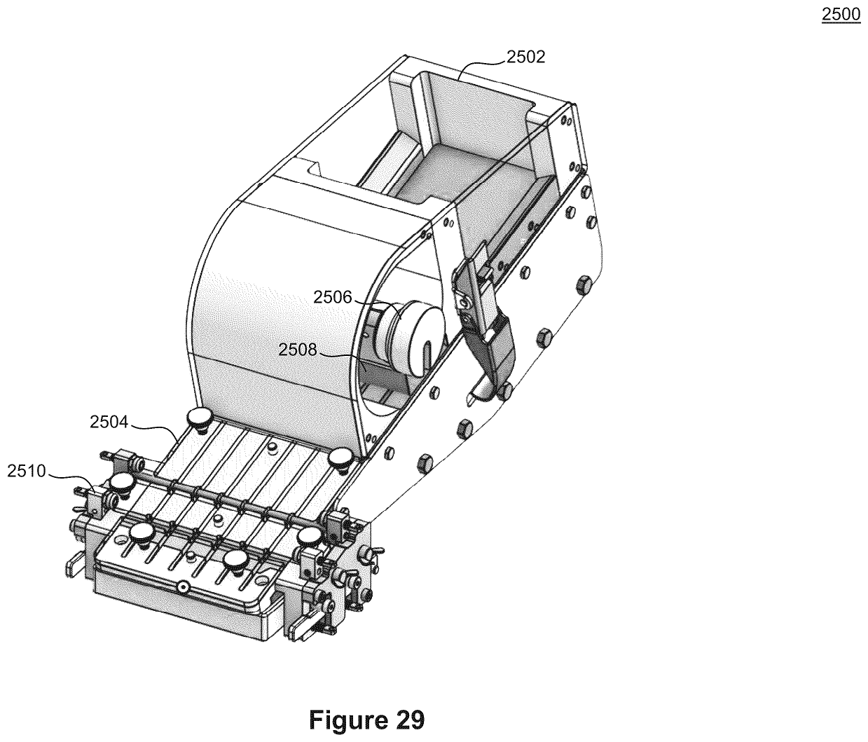

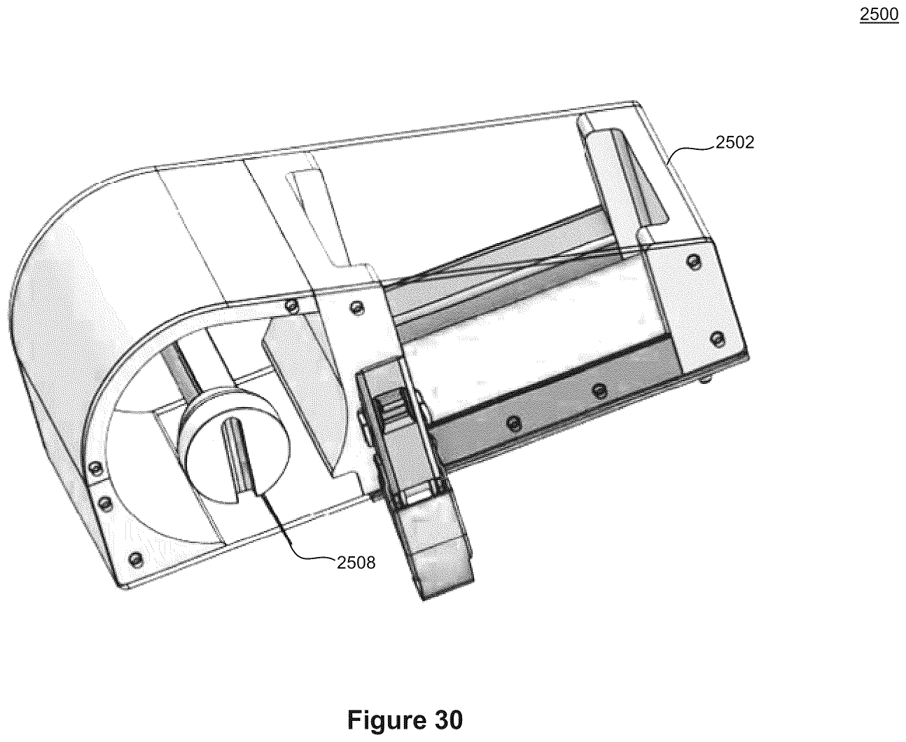

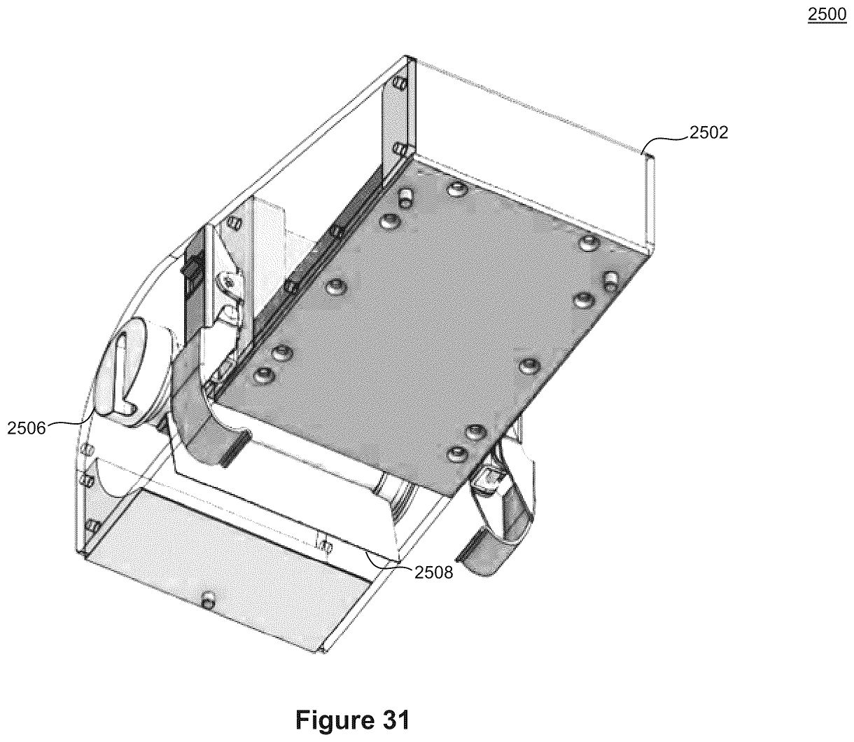

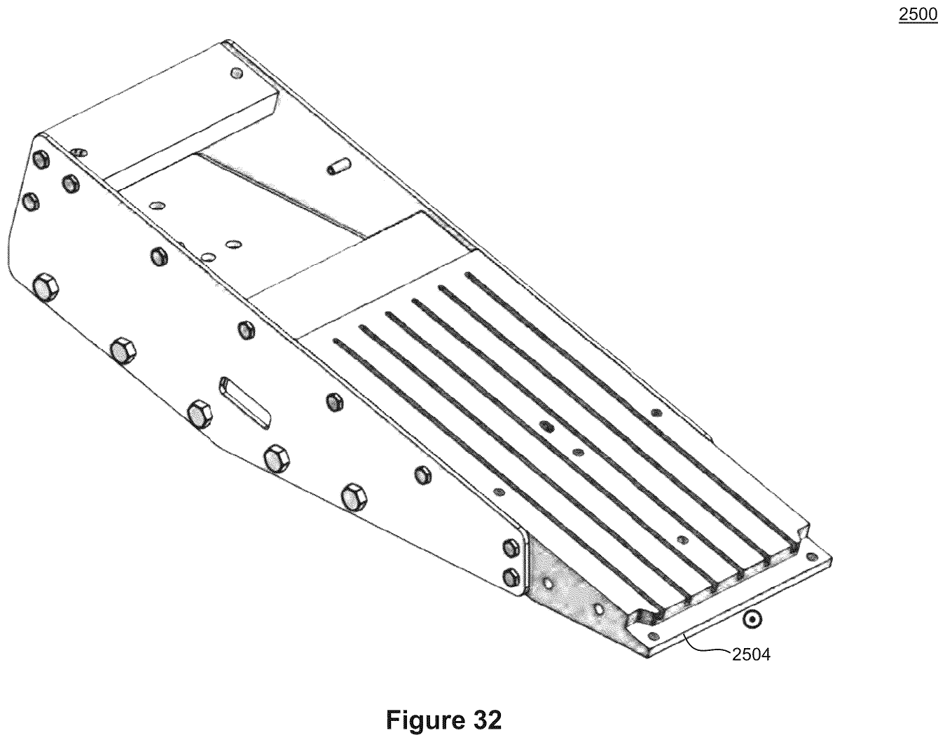

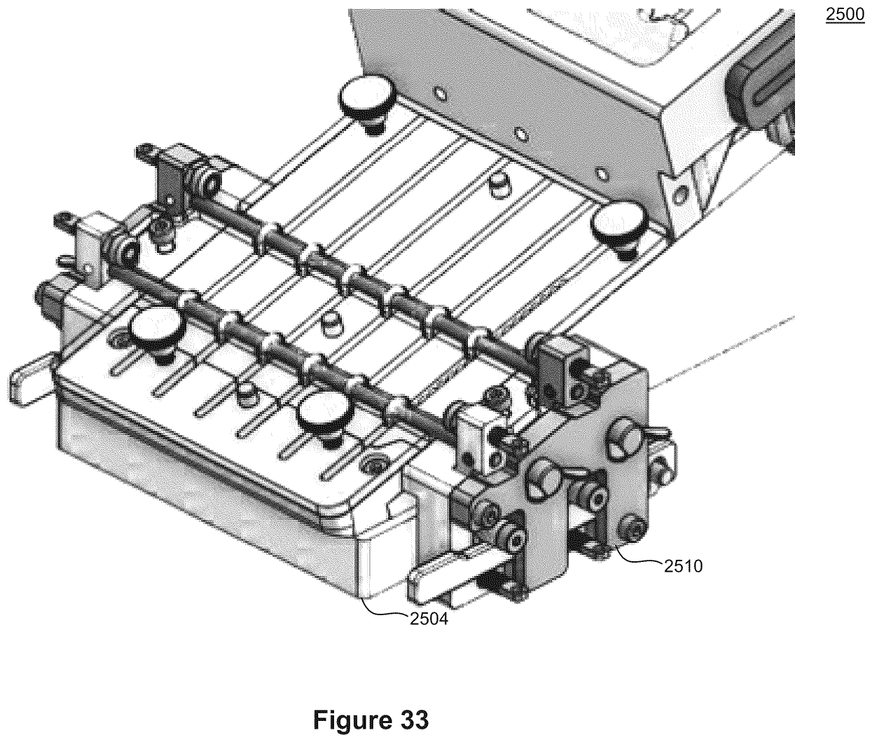

FIGS. 25-33 illustrate an exemplary capsule assembly 2500 apparatus in accordance with some embodiments of the present disclosure. In some embodiments, a capsule assembly apparatus 2500 of the present disclosure is provided in order to facilitating deposition of a plurality of solid dosage forms (e.g., a plurality of solid dosage forms), into a plurality of bodies (e.g., a plurality of capsule bodies). In some embodiments, the capsule assembly apparatus 2500 includes a hopper 2502, which is utilized to retain the plurality of solid dosage forms. In some embodiments, the hopper 2502 includes a plurality of side walls, which prevents the plurality of solid dosage forms from becoming contaminated or accidentally removed from the hopper 2502. Furthermore, the hopper 2502 includes an inlet for receiving a member (e.g., a first dosage form) in the plurality of solid dosage forms. Moreover, the hopper 2502 includes an outlet for conveying the member towards a dispenser 2504.

In some embodiment, the dispenser 2504 includes a channel 2514 or one or more channels in a plurality of channels 2514 that is configured to receive at least a member or two members in the plurality of solid dosage forms. In some embodiments, the channel 2514 includes a first terminal end portion configured to receive the member, and a second terminal end portion configured to discharge the member, which allows cach channel 2514 to at least transport the member. Additionally, in some embodiments, the capsule assembly apparatus 2500 includes a rotary gate 2508 that at least controls the conveying of the member. In some embodiments, the rotary gate 2508 is disposed interposing between the outlet of the hopper 2502 and the dispenser 2504.

More particularly, in some embodiments, the hopper 2502 includes an inlet (configured for receiving a member in the plurality of solid dosage forms. In some embodiments, the hopper 2502 includes an outlet configured for conveying the member in the plurality of solid dosage forms towards the dispenser 2504. For instance, in some embodiments, the outlet includes a tapered portion that narrows in a first direction (e.g., towards the dispenser), such as a funnel, such that the outlet is configured to direct the member in the plurality of dosage forms towards the dispenser 2504. However, the present disclosure is not limited thereto. In some embodiments, the roundness is determined by a degree of abrasion of a particle as shown by a sharpness of an edge portion. Additional details and information regarding the roundness is found at Bates et al., 1980, “Glossary of Geology, 2nd Edition”, American Geological Institute, 2, print, which is incorporated herein by reference in its entirety for all purposes.

In some embodiments, the hopper 2502 is configured such that the inlet is disposed at a first end portion of the hopper 2502. In some embodiments, the outlet of the hopper 2502 is disposed at a second end portion of the hopper 2502. In some embodiments, the second end portion of the hopper 2502 is opposite, or substantially opposite, of the first end portion of the hopper 2502. In some embodiments, the second end portion is perpendicular to the first end portion. In some embodiments, the outlet of the hopper 2502 is located at the bottom end portion of the hopper 2502. Accordingly, in some embodiments, the first end portion is raised in comparison to the second end portion of the hopper 2502, which allows for the plurality of dosage forms to flow towards the second end portion by gravitational forces. In some embodiments, the inlet is loaded from a first end portion (e.g., a rear end portion) of the capsule assembly apparatus 2500, such as a side portion that is facing outwardly from the capsule assembly apparatus. In some embodiments, a surface of the hopper 2502 includes a protrusion, such as a ledge, which restricts a flow of the member towards the rotary gate 2508. For instance, in some embodiments, the surface extends from an upper end portion of the hopper towards a lower end portion of the hopper, forming an opening at the lower end portion of the hopper to restrict the flow of the member towards the rotary gate 2508. However, the present disclosure is not limited thereto.

For instance, in some embodiments, the capsule assembly apparatus further includes the rotary gate 2508 disposed adjacent to the outlet of the hopper 2502. In some embodiments, the rotary gate 2508 is configured to control access by the member in the plurality of solid dosage forms through the outlet of the hopper 2502 towards the channels 2514 of the dispense 2504. In some embodiments, the rotary gate 2508 includes a flipper that is utilized to orient the member in a first direction. In some embodiments, the flipper of the rotary gate 2508 extends from a first surface of the rotary gate to a side wall of a housing that accommodates the hopper 2502 and the rotary gate 2508. Moreover, in some embodiments, a first length of the flipper is greater than a second length of the side wall of the housing. For instance, in some embodiments, and edge portion of the flipper abuts or touches the side wall of the housing. In some embodiments, the flipper includes a first planar surface and a second planar surface opposing the first surface. In some embodiments, the flipper is configured as a single blade flexible paddle that can sweep through a rotational motion when controlled by the actuator 2506. However, the present disclosure is not limited thereto. In some embodiments, the flipper includes the size, thickness, material stiffness or a combination so that the flipper has conformal sweep action to engage with the housing of the hopper 2502 against the track and ramp. In some embodiments, the rotary gate 2508 is configured to traverse a portion of a surface of the hopper, such as a first direction opposite a flow direction of the member (e.g., away from the inlet of the dispenser) in order to orient the member for being received by the channel of the dispenser. In some embodiments, the surface includes a radius of curvature greater than zero. In some embodiments, the surface is at least in part cylindrical. In some embodiments, the surface is at least in part ellipsoidal and/or oblong.

In some embodiments, the rotary gate 2508 includes a sensor and/or an actuator 2506. In some embodiments, the actuator 2506 is supply motion to the rotary gate 2508. In some embodiments, the rotary gate 2508 is configured to separate (e.g., break up, unclog, segregate, etc.) a member from the plurality of solid dosage forms, such as capsules that are disposed on feeder track of the apparatus. In some embodiments, the flipper is configured to control a bulk flow of tablets traveling from the hopper to the slots in the feeder track.

In some embodiments, the rotary gate 2508 includes a plurality of protrusions, such as pins, extending from a surface of the rotary gate 2508, which allows for engaging to a corresponding plurality of channel 2514 of the dispense 2504, such as three pins mating to three slots. Advantageous, in some such embodiments, the hopper 2502 and the rotary gate 2508 regulate the solid dosage forms received by dispenser 2504. However, the present disclosure is not limited thereto.

In some embodiments, the rotary gate 2508 includes no angle adjustability. In some embodiments, the rotary gate 2508 includes angle adjustability. In some embodiments, the rotary gate 2508 includes a ledge that is configured to reduce a plurality of tablets lifting. However, the present disclosure is not limited thereto.

In some embodiments, the cam gate 2510 is disposed interposing between the outlet of the hopper 2502 and the dispenser 2504. In some embodiments, the cam gate 2510 is configured to control the conveying of the member in the plurality of solid dosage forms, such as a speed of the member, an orientation of the member, a spacing between the member and another solid dosage form, or a combination thereof. In some embodiments, the cam gate 2510 includes a first cam configured to control the conveyance of the member in the plurality of solid dosage forms received by the channel 2514 of dispenser 2504. In some embodiments, the first cam includes a bar configured to extend over a portion of each channel 2514. In some embodiments, the bar includes an annular protrusion that extends outwardly (e.g., radially) from a surface of the bar, which is configured to enter a portion of a channel 2514. As a non-limiting example, in some embodiments, the annular protrusion includes an o-ring. In some embodiments, the annular protrusion is sized such that when the cam is in an OPEN state, an edge portion of the annular protrusion is at a first depth of the channel 2514, and when the cam mechanism is in a CLOSED state the annular protrusion is at a second depth of the channel. In some embodiments, the first depth allows for the solid dosage form to pass through the channel 2514 past the cam gate 2510, and the second depth prohibits the passing. However, the present disclosure is not limited thereto. In some embodiments, the cam gate 2510 includes a second cam configured to control the conveying of the member in the plurality of solid dosage forms discharged by the channel 2514. In some embodiments, the first cam and the second cam collectively utilize an actuator. Accordingly, in some such embodiments, the cam gate 2510 allows for receiving a corresponding plurality of solid dosage forms for each channel 2514. Accordingly, by utilizing the second actuation mechanism for both the dispenser 2504 and the cam gate 2510, the capsule assembly apparatus 2500 of the present disclosure does not require a further actuator mechanism to cause movement of the first cam, the second cam, or the dispenser 2504. Furthermore, in some embodiments, the cam gate 2510 prevents breakage of the solid dosage forms, such as by restricting an orientation of the member in the solid dosage form and/or controlling a velocity of the solid dosage form through the channels 2514. However, the present disclosure is not limited thereto. In some embodiments, the cam gate 2510 provides an overflow control, which prevents excess solid dosage forms from flowing through the apparatus 2500.

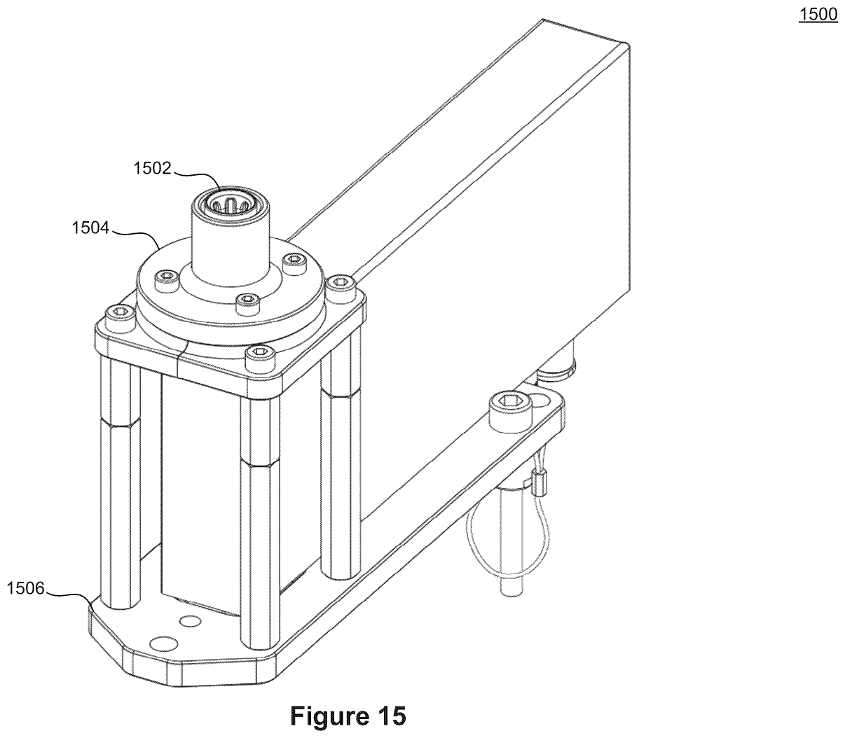

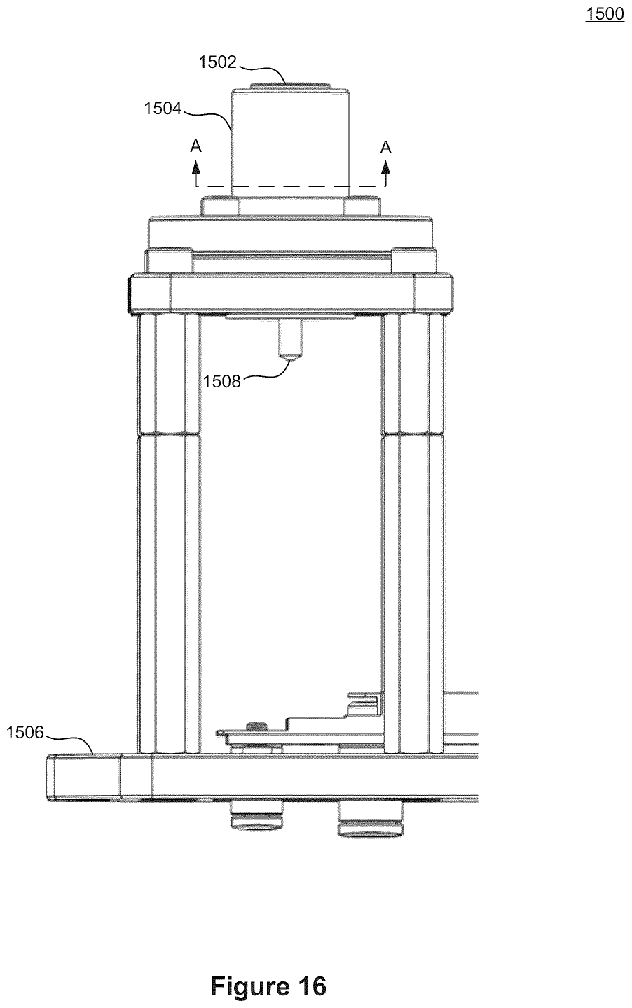

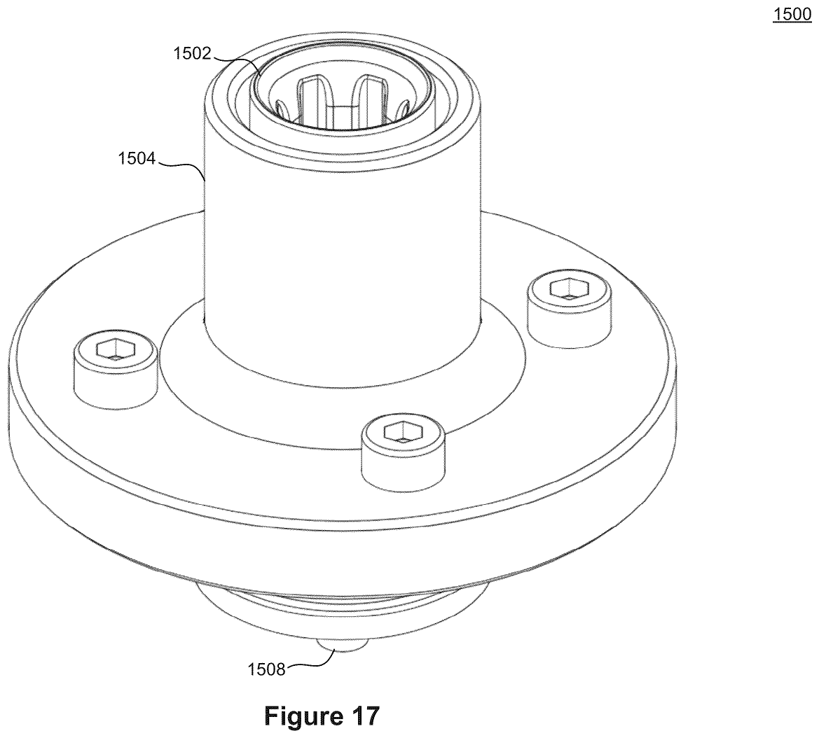

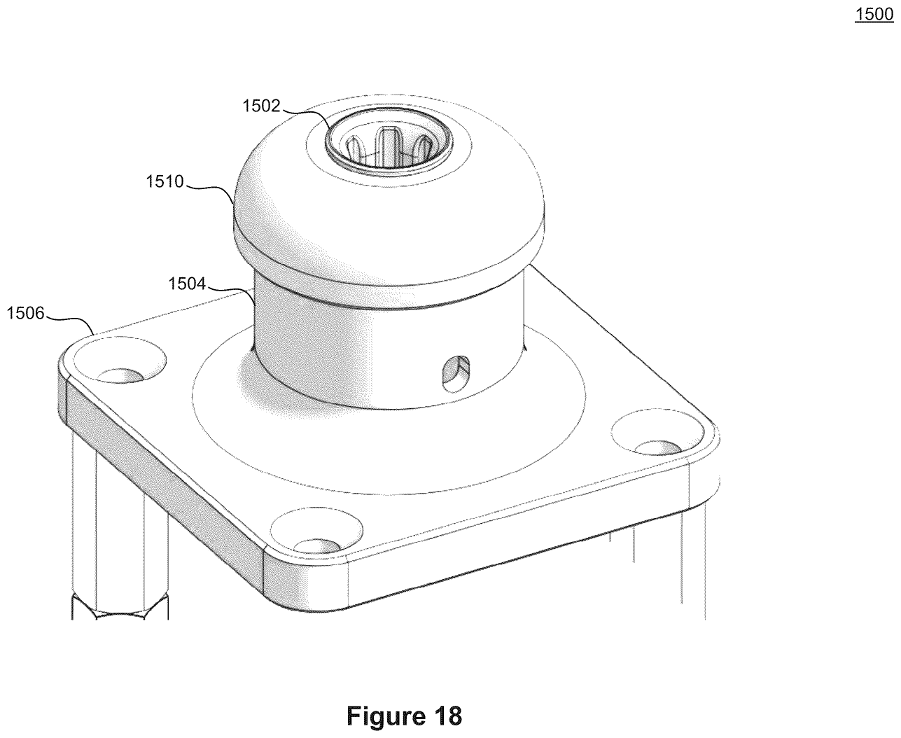

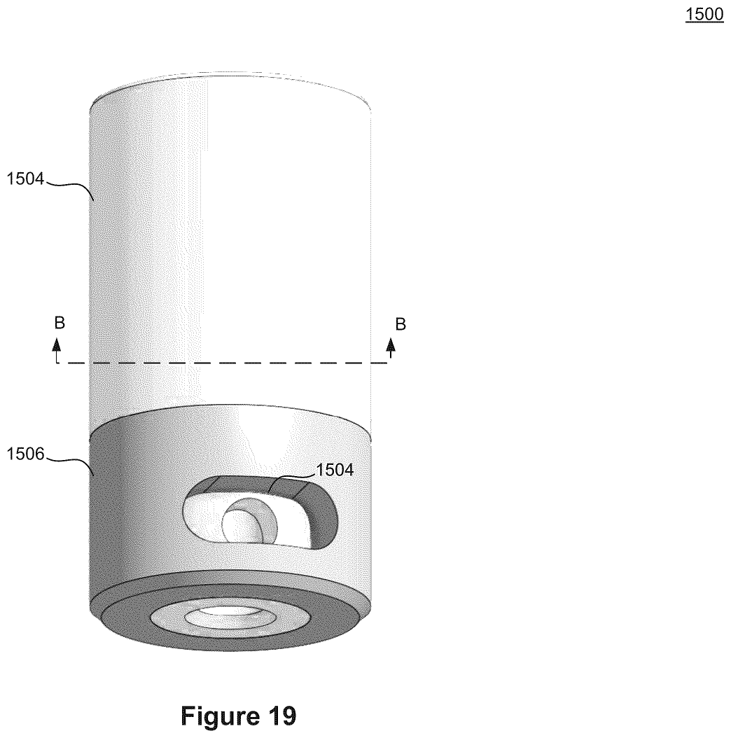

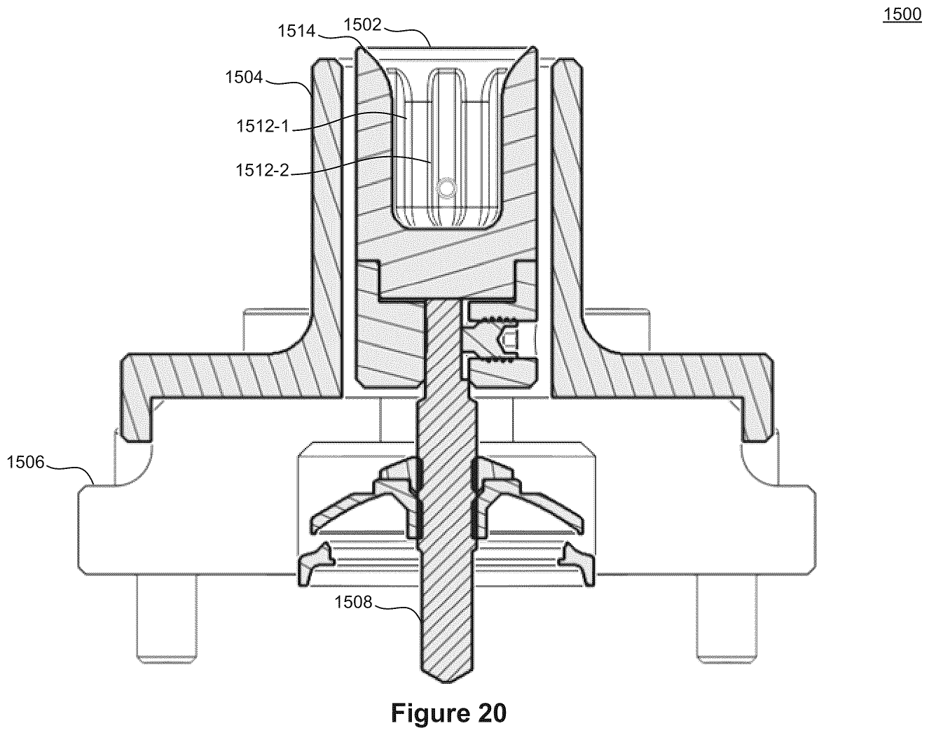

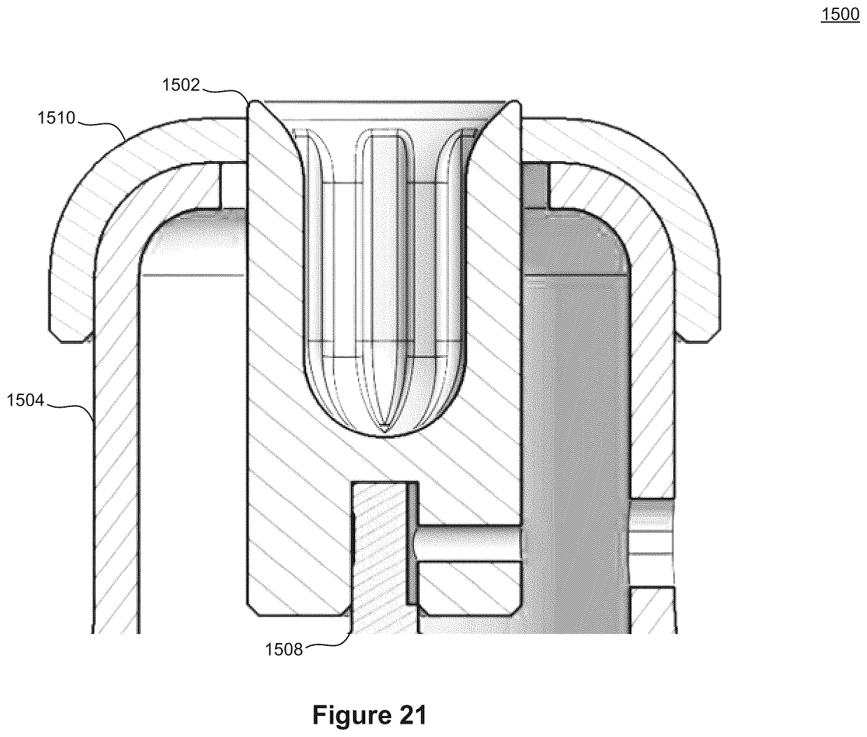

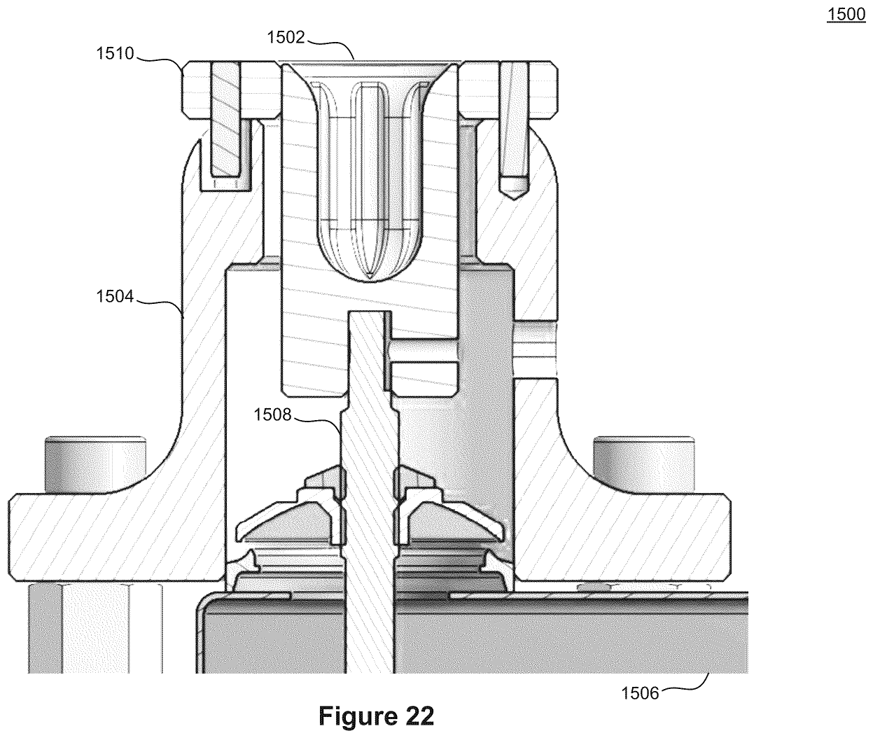

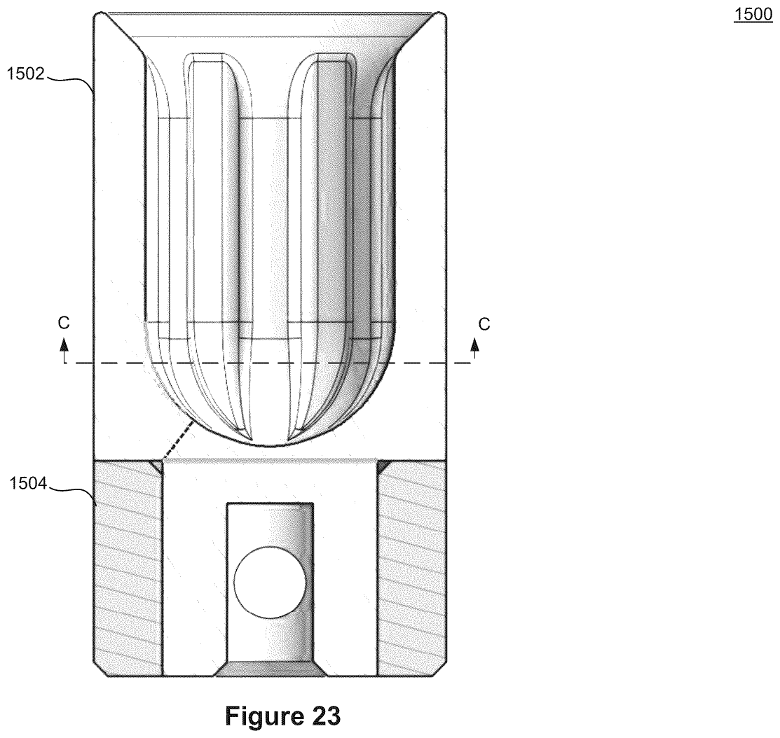

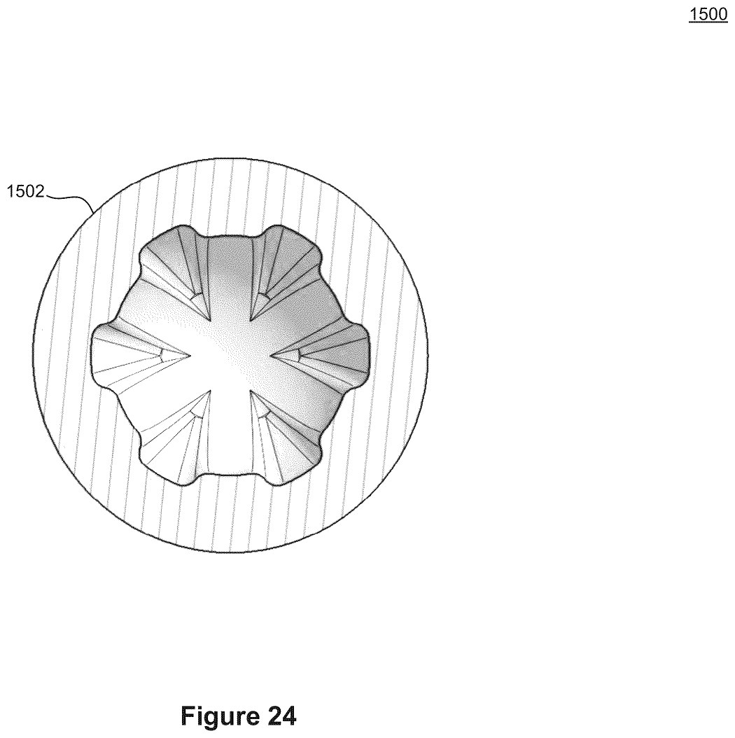

FIGS. 15-24 illustrate an exemplary sensor apparatus 1500 in accordance with some embodiments of the present disclosure. In some embodiments, the sensor apparatus 1500 is configured to determine a mass of, at least, a plurality of bodies or one body. For instance, in some embodiments, the sensor apparatus 1500 includes one or more wind shields 1510, such as one or more sidewalls and/or openings 1510, which is configured to prevent wind from traversing across an upper surface of the sensor apparatus 1500. However, the present disclosure is not limited thereto.

In some embodiments, the sensor apparatus 1500 includes a nest unit 1502 that accommodates a body 5000 or a plurality of bodies 5000. For instance, in some embodiments, the nest unit 1502 including a first opening for receiving the body 500. In some embodiments, the nest unit 1502 includes a side wall 1514 having a contoured surface 1512 or one or more contoured surfaces in a plurality of contoured surfaces 1512. In some embodiments, one or more contoured surfaces 1512 is arranged circumferentially about the sidewall 1514 of the nest unit, which allows for contouring to a shape of the body 5000 for minimal dead space between the sidewall and the exterior of the body. In some embodiments, one or more contoured surface in the plurality of contoured surface is substantially uniformly distributed in a circumferential direction. In some embodiments, an adjacent contoured surface is spaced apart from another contoured surface. In some embodiments, two or more contoured surfaces are symmetrically formed on the side wall. For instance, in embodiments with three contoured surfaces, the contoured surface areas are spaced 120 degrees apart. In some embodiments, the side wall 1514 (e.g., the exterior surface of the side wall) is preferably cylindrical. In some embodiments, the contoured surface 1512 is one or more divots formed on the side wall. In some embodiments, the contoured surface 1512 is a concave arca on the side wall of the holding member of the nest unit. In some embodiments, contoured surface 1512 allows for receiving the body 5000 whilst allow for a flow of air between the exterior of the body 5000 and the side wall 1514.

However, the present disclosure is not limited thereto. For instance, the nest unit 1502 includes 2, 3, 4, 5, 6, 7, 8, 9, 10 or more than 10 contoured surfaces 1512. In some embodiments, the nest unit 1502 includes at least 2, at least 3, at least 4, or at least 5 contoured surfaces 1512. Moreover, in some embodiments, the contoured surface 1512 is formed symmetrically or distributed uniformly. Further, in some embodiments, the one or more contoured surfaces 1512 includes a convex area on the side wall 1514 of the nest unit 1502. In addition, in some embodiments, the one or more contoured surfaces 1512 extend in an axial direction of the side wall 1514 across any portion of the side wall. For instance, in an embodiment, a contoured surface 1512 extends in an axial direction of the side wall 1514 across less than 50%, less than 40%, less than 30% or less than 20% of the side wall. In some embodiments, a contoured surface 1512 extends in an axial direction of the side wall 1514 across at least 50%, at least 60%, at least 70%, at least 80% or at least 90% of the side wall. In some embodiments, the contoured surface 1512 allows for air to escape past a capsule inserted in the nest unit 1502 making the insertion or removal of the capsule casier from the opening. In some embodiments, the contoured surface 1512 provide one or more circumferential gaps for receiving a compound, such as a power, that is undesirable for touching the exterior of the body 5000.

Moreover, the sensor apparatus includes a second opening opposing the first opening, which allows for disposing a center of gravity of the body aligned with a portion of the sensor apparatus, such as a sensor. In some embodiments, the second opening is configured to accommodate a portion of the sensor 1508. Furthermore, in some embodiments, the sensor apparatus includes a first housing 1510. In some embodiments, the first housing includes a first opening configured to accommodate the nest unit 1502, which allows for the nest unit to be received by the first housing 1510. For instance, in some embodiments, the first housing 1510 is configured to receiving some or all of the nest unit. In some embodiments, an upper end portion of the first housing is parallel or substantially parallel, or co-planar, with an upper end portion of the nest unit. In some embodiments, the nest unit is recessed within an interior of the first housing. Moreover, the sensor 1508 is disposed on a base of the sensor apparatus, in which the sensor 1508 includes a translational degree of freedom. In some embodiments, the base 1506 is separate or distinct from the first housing 1510, which prevents the nest unit or housing from interfering with the sensor 1508. However, the present disclosure is not limited thereto. In some embodiments, the first housing is configured to prevent movement of the nest unit in a horizonal movement.

In some embodiments, the sensor apparatus 1500 includes a combined shaft collar and/or the sensor 1508, which forms a single component such as a three-dimensional monolithic structure. However, the present disclosure is not limited thereto. In some embodiments, the sensor apparatus 1500 includes a shoulder that is configured to prevent the sensor 1508 from twisting during assembly. However, the present disclosure is not limited thereto. In some embodiments, the sensor apparatus 1500 includes a limit flag made part of the top shaft collar. However, the present disclosure is not limited thereto.

In some embodiments, the sensor apparatus 1500 further includes a second housing 1504. In some embodiments, the second housing 1504 includes a second opening further including a second diameter less than a first diameter of the first housing 1514. In some embodiments, the first housing is disposed on an upper surface of the second housing, which allows for the nest unit to rest above the sensor. However, the present disclosure is not limited thereto. In some embodiments, the first housing and the second housing do not physically contact, which allows for the nest unit to be disposed on an end portion of the sensor 308. For instance, in some embodiments, the second housing is configured as a stop to prevent the next unit and/or the first housing from applying excessive force to the sensor. However, the present disclosure is not limited thereto. In some embodiments, the second housing is configured to surround some or all of the base and the sensor. In some embodiments, the second housing does not physically touch the sensor. In some embodiments, the second housing prevents undesired force or torque from being applied to the sensor. However, the present disclosure is not limited thereto. In some embodiments, the second housing includes a flange surrounding some or all of the sensor 1508, which limits movement of the nest unit above the sensor. In some embodiments, the sensor 1508 includes a mass sensor 1508. In some embodiments, the sensor 1508 continuously determines a mass of the nest unit 1502. In some embodiments, the sensor includes a strain gauge, a load cell, piezoelectric sensor, a microelectromechanical system (MEMS), or a combination thereof. However, the present disclosure is not limited thereto. Accordingly, the sensor assembly 1500 allows for determining a mass of an object, such a body 5000 or a plurality of bodies 5000, accommodated by the nest assembly while protecting both the nest assembly and the sensor from external mechanical interferences, such as wind, excessive loads, and contaminant particles.

In some embodiments, the systems, methods, and apparatuses of the present disclosure include one or more systems, methods, apparatuses, and devices of United States Patent Publication no.: 2024-0009136 A1; United States Patent Publication no.: 2023-0365911 A1; United States Patent Publication no.: 2023-0228784 A1; United States Patent Publication no.: 2023-0102750 A1; United States Patent Publication no.: 2022-0325219 A1 1; United States Patent Publication no.: 2019-0016048 A1; U.S. Pat. Nos. 11,198,845; 10,773,392; 11,142,353; 9,845,167; 10,456,975; and U.S. patent application Ser. No. 17/823,065, each of which is incorporated herein by reference in its entirety for all purposes.

### REFERENCES CITED AND ALTERNATIVE EMBODIMENTS

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that includes a computer program mechanism embedded in a non-transitory computer-readable storage medium. These program modules can be stored on a CD-ROM, DVD, magnetic disk storage product, USB key, or any other non-transitory computer readable data or program storage product.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed is:

1. A funnel apparatus comprising
a base comprising
a first surface comprising a plurality of openings, wherein each opening in the plurality of openings comprises a first length for receiving a body, and
a second surface substantially perpendicular to the first surface, the second surface comprising a connecting member disposed on the second surface; and
a tray comprising
a third surface comprising a plurality of through-holes, wherein each through-hole in the plurality of through-holes substantially aligns with a corresponding opening in the plurality of openings of the base, and
a fourth surface substantially perpendicular to the third surface comprising a mating member for receiving the connecting member of the base.

2. The funnel apparatus of claim 1, wherein the first surface is recessed from and perpendicular to the second surface.

3. The funnel apparatus of claim 1, wherein the first surface and the third surface each comprises a flat plane.

4. The funnel apparatus of claim 1, wherein each opening in the plurality of openings and/or each through-hole in the plurality of through-holes comprises a rounded edge portion, a chamfer edge portion, a beveled edge portion, or a combination thereof.

5. The funnel apparatus of claim 1, wherein each opening in the plurality of openings and/or each through-hole in the plurality of through-holes comprises
a first chamfer extending about a periphery of the respective opening or the respective through-hole, and
a second chamfer extending about a periphery of the first chamfer and a side-wall of the respective opening or the respective through-hole.

6. The funnel apparatus of claim 5, wherein a first length of the first chamfer is less than a second length of the second chamfer.

7. The funnel apparatus of claim 5, wherein a first angle of the first chamfer is less than a second angle of the second chamfer.

8. The funnel apparatus of claim 1, wherein the plurality of openings forms a first array, and wherein a center of the first array is offset from a center of the first surface.

9. The funnel apparatus of claim 1, wherein the plurality of through-holes forms a second array, and wherein a center of the second array is offset from a center of the third surface.

10. The funnel apparatus of claim 1, wherein the base comprises a first gate disposed on the second surface, and wherein the tray comprises a second gate disposed on the fourth surface.

11. The funnel apparatus of claim 1, wherein each opening in the plurality of openings comprises a lower surface comprising concave curvature.

12. The funnel apparatus of claim 1, wherein
the base comprises a first side wall extending upwardly from the first surface; and
the tray comprises a second side extending downwardly from the third surface, and wherein an interior surface of the second surface is configured to be accommodated by the first side wall of the base.

13. The funnel apparatus of claim 1, wherein the connecting member comprises a first protrusion, and wherein the mating member comprises a first groove for receiving the first protrusion.

14. The funnel apparatus of claim 1, wherein the connecting member comprises a second groove, and wherein the mating member comprises a second protrusion accommodated by the second groove.

15. A capsule assembly apparatus comprising:
a hopper configured to retain a plurality of a solid dosage forms, wherein the hopper comprises:
an inlet for receiving a member in the plurality of solid dosage forms, and
an outlet for conveying the member in the plurality of solid dosage forms towards a dispenser;
the dispenser comprising a plurality of channels configured to receive the member in the plurality of solid dosage forms at an inlet of a respective channel and dispense the member at an outlet of the respective channel;
a rotary gate disposed interposing between the outlet of the hopper and the inlet of each channel in the plurality of channels, wherein the rotary gate is configured to control conveying of the member in the plurality of solid dosage forms; and
an actuator configured to control a movement of the rotary gate in a first direction.

16. The capsule assembly apparatus of claim 15, wherein the outlet of the hopper is disposed at a position at or above of the maximum height of the respective channel of the dispenser.

17. The capsule assembly apparatus of claim 15, wherein the rotary gate comprises a flipper extending from a first surface of the rotary gate to a side wall of a housing accommodating the hopper and the rotary gate.

18. The capsule assembly apparatus of claim 17, wherein the flipper comprises a first planar surface and a second planar surface opposing the first surface.

19. The capsule assembly apparatus of claim 17, wherein the flipper comprises a flexible material.

20. The capsule assembly apparatus of claim 17, wherein a first length of the flipper is greater than a second length of the side wall of the housing.

21. The capsule assembly apparatus of claim 15, wherein the rotary gate possess two rotational degrees of freedom.

22. The capsule assembly apparatus of claim 15, wherein capsule assembly apparatus further comprises a cam gate comprising:
a first cam configured to control the conveyance of the member in the plurality of solid dosage forms received by the channel, and
a second cam configured to control the conveying of the member in the plurality of solid dosage forms discharged by the channel.

23. The capsule assembly apparatus of claim 22, wherein the first cam and the second cam collectively utilize an actuator.

24. The capsule assembly apparatus of claim 15, wherein the capsule assembly apparatus further comprises a sliding gate disposed below a lower surface of the dispenser, wherein the sliding gate is configured to control discharge of the member in the plurality of solid dosage forms from the dispenser.

25. The capsule assembly apparatus of claim 24, wherein the sliding gate comprises a metering plate.

26. The capsule assembly apparatus of claim 25, wherein the sliding gate is configurable between
a first position in which an aperture of a metering hole of the metering plate and an aperture of a dispensing hole in the dispenser are misaligned, and
a second position in which the aperture of the metering hole and the aperture of the dispensing hole are aligned.

27. The capsule assembly apparatus of claim 15, wherein the dispenser further comprises a surface extending from an upper end portion of the dispenser towards the outlet of the hopper.

28. The capsule assembly apparatus of claim 15, wherein each solid dosage form in the plurality of solid dosage forms comprises a first size between 2 mm and 35 mm.

29. The capsule assembly apparatus of claim 15, wherein each solid dosage form in the plurality of solid dosage forms comprises a rotationally symmetrical body comprising a side wall and a base.

30. A gripping apparatus comprising:
a rotary actuator;
a rotary linkage comprising
a first end portion at least partially disposed about a periphery of the rotary actuator, and
a second end portion extending outwardly from the first end portion;
a plurality of intermediate linkages coupled to the second end portion of the rotary linkage, each intermediate linkage in the plurality of intermediate linkages comprising
an input end portion coupled to the second end portion of the rotary linkage,
an output end portion disposed below the input end portion, and
a jaw disposed on the output end portion; and
a plurality of compliance linkages, wherein each compliance linkage in the plurality of compliance linkages comprises
a first end portion coupled to either the output end portion or the jaw of a respective intermediate linkage, and
a second end portion substantially orthogonal to the respective intermediate linkage.

31. The gripping apparatus of claim 30, wherein a distance travelled between an OPEN state and a CLOSED state of each jaw is 15 millimeters or less.

32. The gripping apparatus of claim 30, wherein the gripping apparatus further comprises a mount comprising a first end portion coupled to the rotary actuator and a second end portion coupled to the second end portion of each compliance linkage in the plurality of compliance linkages.

33. The gripping apparatus of claim 30, wherein each jaw is selected from the group consisting of a tentacle, a cup, a cone, a chuck, a latch, a hook, a clamp, a pincer, a tong, or a combination thereof.

34. The gripping apparatus of claim 33, wherein each compliance linkage in the plurality of compliance linkages comprises one or more side walls, wherein each side wall in the one or more side walls extends downwardly from a first surface of the rotary actuator to a corresponding jaw.

35. The gripping apparatus of claim 30, wherein each intermediate linkage in the plurality of intermediate linkages translated rotational motion of the rotary linkage into translational motion of the jaw.

36. The gripping apparatus of claim 30, wherein each compliance linkage in the plurality of compliance linkages resists motion parallel to a rotational axis of the rotary actuator.

37. The gripping apparatus of claim 30, wherein each compliance linkage in the plurality of compliance linkages is configured to prevent movement beyond a predetermined limit.

38. The gripping apparatus of claim 30, wherein each jaw is disposed at a distal end portion of the gripping apparatus.

39. A sensor apparatus comprising
a nest unit comprising
a first opening, wherein the first opening comprises a side wall comprising a plurality of contoured surfaces arranged circumferentially about the side wall, and
a second opening opposing the first opening, wherein the second opening is configured to accommodate a portion of a sensor; and
a first housing comprising a first opening configured to accommodate the nest unit; and
the sensor is disposed on a base, wherein the sensor comprises a translational degree of freedom.

40. The sensor apparatus of claim 39, wherein the sensor apparatus further comprises a second housing comprising a second opening comprising a second diameter less than a first diameter of the first housing.

41. The sensor apparatus of claim 40, wherein the first housing is disposed on an upper surface of the second housing.

42. The sensor apparatus of claim 40, wherein the second housing is configured to surround some or all of the base and the sensor.

43. The sensor apparatus of claim 40, wherein the second housing comprises a flange surrounding some or all of the sensor.

44. The sensor apparatus of claim 39, wherein the side wall is cylindrical.

45. The sensor apparatus of claim 39, wherein adjacent contoured surfaces in the plurality of contoured surfaces are spaced apart from each other.

46. The sensor apparatus of claim 39, wherein contoured surfaces in the plurality of contoured surfaces are substantially uniformly distributed in a circumferential direction.

47. The sensor apparatus of claim 39, wherein the plurality of contoured surfaces comprises at least 2, at least 3, at least 4, or at least 5 contoured surfaces.

48. The sensor apparatus of claim 39, wherein each contoured surface comprises a concave portion of the side wall.

49. The sensor apparatus of claim 39, wherein the sensor comprises a mass sensor.

50. The sensor apparatus of claim 39, wherein the sensor continuously determines a mass of the nest unit.
